(19) United States
(12) Patent Application Publication
(10) Pub. No.: US 2022/0199968 A1
(43) Pub. Date: Jun. 23, 2022

(54) LASER CUTTING OF COMPONENTS FOR ELECTROCHEMICAL CELLS

(71) Applicant: Sion Power Corporation, Tucson, AZ (US)

(72) Inventors: David Child, Tucson, AZ (US); Troy Shannon, Tucson, AZ (US); Chariclea Scordilis-Kelley, Tucson, AZ (US); Enic Azalia Quero-Mieres, Tucson, AZ (US)

(73) Assignee: Sion Power Corporation, Tucson, AZ (US)

(21) Appl. No.: 17/552,829

(22) Filed: Dec. 16, 2021

Related U.S. Application Data
(60) Provisional application No. 63/129,442, filed on Dec. 22, 2020.

(51) Int. Cl. H01M 4/134; H01M 4/46

(52) U.S. Cl. CPC H01M 4/134; H01M 2004/021; H01M 4/463

(57) ABSTRACT

Methods for laser cutting electrodes and electrodes with modified edges are generally described.

### RELATED APPLICATIONS

This application claim priority to U.S. Provisional Application No. 63/129,442, filed Dec. 22, 2020, which is incorporated herein by reference in its entirety.

### TECHNICAL FIELD Methods of laser cutting components for electrochemical cells and related articles are generally described.

### BACKGROUND

Electrodes can be prepared by forming a slurry containing a particular electroactive material and depositing the slurry on a current collector followed by evaporating the liquid from the slurry to form an electroactive layer disposed on the current collector. The electrode may then be sized and shaped to use in an electrochemical cell, such as a battery. In order to fit the particular dimensions of the electrochemical cell, the electrode may be cut to adequately match of the measurements of the cell.

### SUMMARY

Electrodes comprising an electroactive layer in which one or more edges are impermeable to an electroactive species, and related methods, are generally described. The subject matter of the present disclosure involves, in some cases, interrelated products, alternative solutions to a particular problem, and/or a plurality of different uses of one or more systems and/or articles.

In one aspect, an electrode is described. In some embodiments, the electrode comprises an electroactive layer comprising an electroactive material configured to intercalate and/or deintercalate an electroactive species. In some embodiments, the electroactive layer comprises a non-electroactive material disposed on an edge of on the electroactive layer, wherein the non-electroactive material is impermeable to the electroactive species.

In another aspect, an electrode is described. In some embodiments, the electrode comprises an electroactive layer comprising a plurality of particles. In some embodiments, the plurality of particles comprises an electroactive material configured to intercalate and/or deintercalate an electroactive species. In some embodiments, an edge of the electroactive layer comprises at least a portion of the plurality of particles that are fused particles. In some embodiments, an interior portion of the electroactive layer comprises at least a portion of the plurality of particles that are unfused particles.

In another aspect, an is described electrode. In some embodiments, the electroactive layer comprises a first material. In some embodiments, the first material is single crystalline. In some embodiments, an edge of the electroactive layer comprises a second material. In some embodiments, the second material is polycrystalline or amorphous.

In another aspect, an electrode is described, the electrode comprising a current collector with a front surface and an opposing back surface, an electroactive layer disposed on the front surface and the back surface of the current collector, the electroactive layer having a cross section, wherein the electroactive layer comprises an electroactive material configured to intercalate and/or deintercalate an electroactive species, a first separator adjacent to the front surface, and a second separator adjacent to the back surface, wherein the first separator and the second separator are in conformal contact with the electroactive layer, and wherein the first separator and the second separator surround a perimeter of the cross section of the electroactive layer.

In a different aspect, a method of cutting an electrode is described. In some embodiments, the method comprises applying a laser to an electroactive layer comprising a plurality of unfused particles, cutting the electroactive layer forming an edge around the electroactive layer, and fusing at least some of the unfused particles along the edge of the electroactive layer to form fused particles at the edge of the electroactive layer.

In another aspect, a method of cutting an electrode is described. In some embodiments, the method comprises applying a laser to an electroactive layer comprising a first material. In some embodiments, the first material is single crystalline. In some embodiments, the method comprises cutting the electroactive layer to form an edge around the electroactive layer and altering the first material along the edge of the electroactive layer into a second material. In some embodiments, the second material is polycrystalline or amorphous.

Other advantages and novel features of the present disclosure will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1C are a schematic cross-sectional side views of an electroactive layer that is being cut with a laser, according to some embodiments;

FIG. 1D is a schematic cross-sectional side view of an electroactive layer deposited on a surface of a current collector, according to some embodiments;

FIG. 1E is a schematic cross-sectional side view of a current collector with an electroactive layer deposited on a front surface and an opposing back surface of the current collector, according to some embodiments;

FIG. 1F is a schematic cross-sectional side view of a laser cutting an electroactive layer disposed on a current collector, according to some embodiments;

FIG. 1G is schematic cross-sectional side view of a laser-cut electroactive layer on a current collector showing a cut edge, according to some embodiments;

FIG. 1H is a schematic cross-sectional side view of a laser cut electrode with angled edges, according to some embodiments;

FIGS. 2A-2D show schematic illustrations of shapes with interior portions of a laser-cut electroactive layer bound by edges, according to one set of embodiments;

FIG. 3A is a schematic top view of an electroactive layer prior to cutting, according to some embodiments;

FIG. 3B is a schematic top view of an electroactive layer after laser cutting and shows cut edges comprising a second material and an interior portion of the electroactive layer comprising a first material, according to some embodiments;

FIG. 3C is a schematic top view of an electroactive layer prior to cutting comprising a plurality of unfused particles, according to some embodiments;

FIG. 3D is a schematic top view of an electroactive layer after laser cutting and illustratively shows cut edges comprising a plurality of fused particles and an interior portion of the electroactive layer comprising a plurality of unfused particles, according to some embodiments;

FIGS. 4A-4C show a schematic cross-sectional view of unfused and fused particles, according to some embodiments;

FIG. 5A is a schematic cross-sectional side view of electroactive layers disposed on a front surface and a back surface of a current collector with a first separator adjacent to a front surface of the electroactive layer and a second separator adjacent to a back surface of the electroactive layer, according to some embodiments;

FIG. 5B is a schematic cross-sectional side view of a first and second separator forming a conformal envelope surrounding a perimeter of a cross section of an electroactive layer, according to some embodiments; and

FIGS. 6A-6D show SEM images of laser-cut electrodes, according to some embodiments.

### DETAILED DESCRIPTION

Electrodes for electrochemical cells (e.g., batteries) may require cutting in order to fit the particular size and shape of the cell. An electrode can be prepared by applying an electroactive layer comprising an electroactive material to a current collector and cutting the electroactive layer and the current collector. Certain existing cutting systems and methods use blades or pre-shaped dies to cut the electroactive layer along with the current collector. However, cutting in this manner presents several disadvantages. For example, blade cutting or die cutting the electroactive layer or the current collector can damage the cutting instrument, especially when the electroactive layer or the current collector are of a relatively high hardness. In addition, cutting using these existing systems and methods may damage the electroactive layer as portions (e.g., dust) of the electroactive layer can delaminate from the current collector upon cutting with a blade or die. As another disadvantage, cutting the electroactive layer into a particular shape may require complex machining of a die into said shape and if the die is damaged when cutting, it may need to be replaced frequently, which can be costly and inefficient. As yet another disadvantage, electrodes cut using these existing systems and methods may have electroactive edges that form dendrites of the electroactive species. For example, lithium metal dendrites may form in the case of lithium-based batteries.

In contrast to certain existing approaches, the present disclosure describes systems and methods for cutting an electrode using a laser. The present disclosure also describes electrodes with modified edges (e.g., non-electroactive edges). As described in more detail below, a laser may be used to cut an electrode from an electroactive layer positioned on a current collector or any other suitable substrate. Cutting with a laser provides many advantages over certain existing systems and methods for cutting electrodes. For example, laser cutting does not require any blades or dies and so the cutting instrument (i.e., the laser) cannot be damaged during the cutting process. This also allows for cutting many electrodes in succession without needing to replace the laser in between each cut. Advantageously, cutting the electroactive layer with a laser may physically and/or chemically modify one or more edges of the cut electroactive layer, which can deactivate the edge towards the electroactive species and, for example, block intercalation of the electroactive species into the edges of the electroactive layer. Preventing one or more edges of the electroactive layer from interacting with the electroactive species may reduce or eliminate the formation of dendrites. For example, in the case of lithium batteries where the electroactive species is a lithium species (e.g., a lithium cation), the formation of lithium metal dendrites may be prevented by deactivating one or more edges of the electroactive layer. As yet another advantage, laser cutting does not require pre-formed dies or blades and so it may be used to cut electrodes in any suitable size or shape as desired. Laser cutting may be particularly useful in cutting cathode active materials disposed on a current collector; however, it should be understood that laser cutting as described herein may be used to cut anode materials as this disclosure is not so limited.

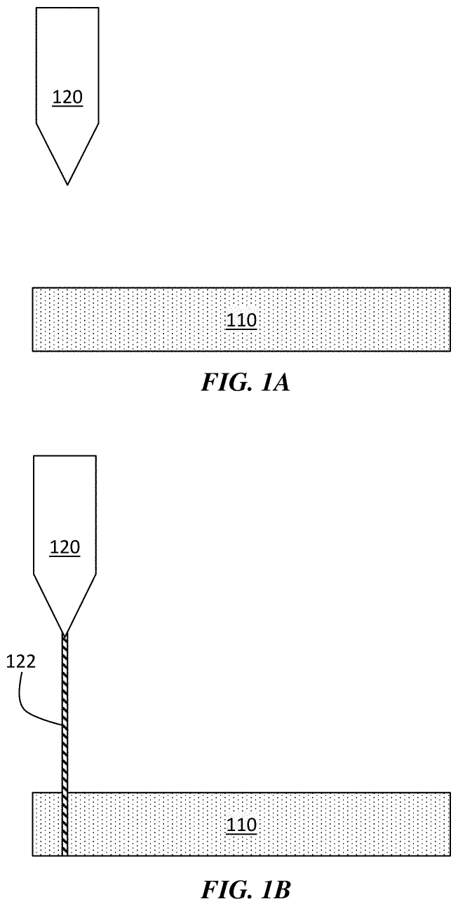

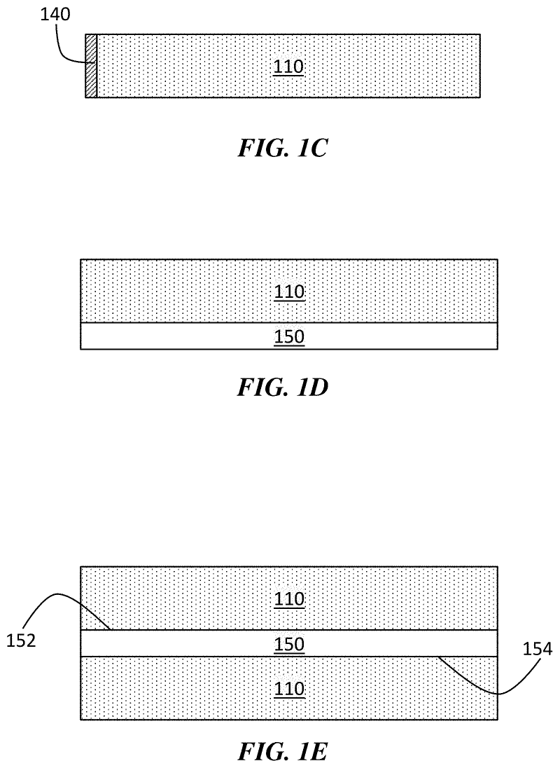

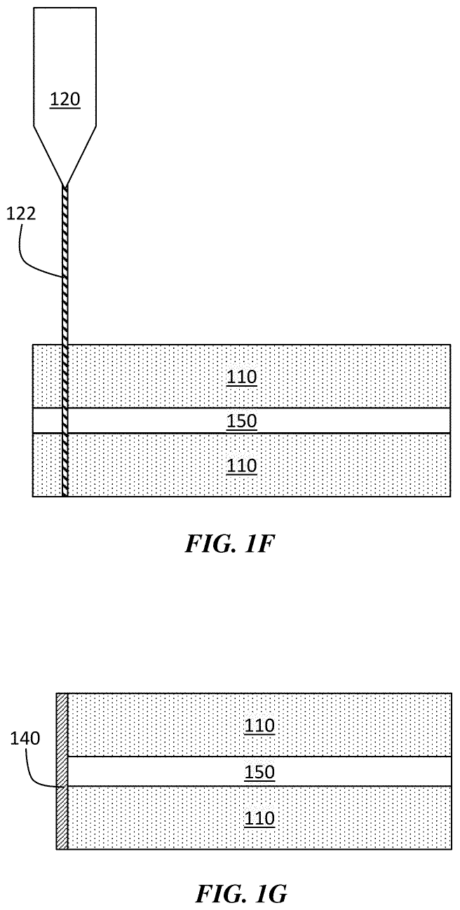

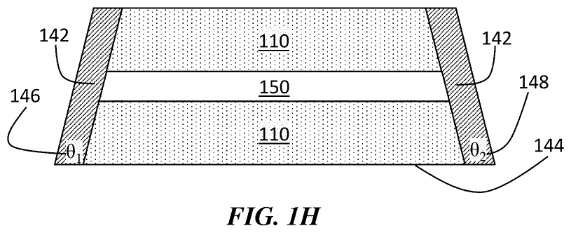

In some embodiments, a method of cutting an electrode with a laser is provided. The laser may be used to cut an electroactive layer, which may be used to form at least a portion of the electrode. For example, in FIG. 1A, an electroactive layer 110 is positioned proximate to a laser 120. The laser 120 may be used to cut the electroactive layer 110 by emitting a laser beam 122 towards the electroactive layer 110, shown illustratively in FIG. 1B. After cutting with the laser, the electroactive layer may comprise a cut edge. For example, in FIG. 1C, the electroactive layer 110 has been cut by the laser 120 and comprises a laser-cut edge 140.

In some embodiments, the electrode may be cut from a substrate (e.g., a current collector) with an electroactive layer disposed on the substrate. For example, as shown illustratively in FIG. 1D, a current collector 150 (or any other suitable substrate) may have an electroactive layer 110 disposed on a surface of the current collector 150. In some embodiments, more than one electroactive layer may be disposed on a substrate. For example, in FIG. 1E, electroactive layers 110 are disposed on a front surface 152 of the current collector 150 and an opposing back surface 154 of the current collector 150.

While FIG. 1E shows an electroactive layer disposed on a front surface and an opposing back surface of the current collector, it should be understood that, in some embodiments, other orientations of the electroactive layer on the current collector are possible. In some embodiments, one electroactive layer is disposed adjacent to one side of the current collector, as shown illustratively in FIG. 1D, while in some embodiments, one or more electroactive layers is disposed on one or more sides of the current collector.

It should be understood that when a portion (e.g., a layer, a structure, a region) is “on”, “adjacent”, “above”, “over”, “overlying”, or “supported by” another portion, it can be directly on the portion, or an intervening portion (e.g., layer, structure, region) may also be present. Similarly, when a portion is “below” or “underneath” another portion, it can be directly below the portion, or an intervening portion (e.g., layer, structure, region) may also be present. A portion that is “directly adjacent”, “directly on”, “immediately adjacent”, “in contact with”, or “directly supported by” another portion means that no intervening portion is present. It should also be understood that when a portion is referred to as being “on”, “above”, “adjacent”, “over”, “overlying”, “in contact with”, “below”, or “supported by” another portion, it may cover the entire portion or a part of the portion.

In some embodiments, the method comprises applying a laser to one or more electroactive layers. For example, as shown illustratively in FIG. 1F, the laser 120 applies the laser beam 122 to the electroactive layer 110 thereby penetrating through the electroactive layer 110 and the current collector 150 so as to cut the electroactive layer 110 and the current collector 150. Cutting the electroactive layer may form an edge around the electroactive layer, as shown illustratively in FIG. 1G, where a cut edge 140 is formed adjacent to electroactive layer 110 where laser beam 122 has cut the electroactive layer 110. Details regarding the laser are described in more detail elsewhere herein.

Applying and/or cutting the electroactive layer with the laser may chemically and/or physical alter a first material of the electroactive layer along the laser-cut edge to form a second material. For example, the cut edge 140 in FIG. 1G may comprise a second material that is distinct (i.e., comprises a different phase) relative to the first material. That is to say, the first material may be altered by the application of the laser along the edge (e.g., the laser-cut edge) into a second material that is different than the first material, which is described in more detail further below.

In some embodiments, the laser-cut edge can be angled relative to a surface normal (i.e., perpendicular) to the current collector and/or the electroactive layer. For example, as shown illustratively in FIG. 1H, angled cut edges 142 are adjacent to the electroactive layer 110 and the current collector 150. The angled cut edges 142 are at an angle, a first angle 146 and a second angle 148, relative to a surface normal to a bottom edge or surface 144 of electroactive layer 110. The angle may also be measured relative to the planar surface of one or more layers in the electrode stack. The angles of the cut edges may be the same or different. Providing angled cut edges may advantageously allow for the fabrication of more complex sizes and shapes of cut electrodes relative to certain existing electrode cutting systems that use blades or die cuts where it had not been possible or was more difficult to provide such angled cuts. For example, in some embodiments, an angled cut may provide a smooth transition between the laser-cut electrode (e.g., a cathode) and another component of an electrochemical cell (e.g., an anode) rather than discontinuous transition (e.g., a step) between the two components, which can minimize sharp edges that can damage other components of an electrochemical cell (e.g., a separator layer, a protective layer).

In some embodiments, the first angle and/or the second angle is less than or equal to 70 degrees, less than or equal to 65 degrees, less than or equal to 60 degrees, less than or equal to 55 degrees, less than or equal to 50 degrees, less than or equal to 45 degrees, less than or equal to 40 degrees, less than or equal to 35 degrees, less than or equal to 30 degrees, less than or equal to 25 degrees, less than or equal to 20 degrees, less than or equal to 15, less than or equal to 10 degrees, or less than or equal to 5 degrees. In some embodiments, the first angle and/or the second angle is greater than or equal to 5 degrees, greater than or equal to 10 degrees, greater than or equal to 15 degrees, greater than or equal to 20 degrees, greater than or equal to 25, greater than or equal to 30 degrees, greater than or equal to 35, greater than or equal to 40 degrees, greater than or equal to 45 degrees, greater than or equal to 50 degrees, greater than or equal to 55 degrees, greater than or equal to 60 degrees, greater than or equal to 65 degrees, or greater than or equal to 70 degrees. Combinations of the above-referenced ranges are also possible (e.g., greater than or equal to 30 degrees and less than or equal to 70 degrees). Other ranges are also possible. It should be understood that the first angle and the second angle may be the same or different. As mentioned above, in some embodiments, the first angle and/or the second angle may be measured relative to a surface normal to the current collector and/or the electroactive layer. In some embodiments, first angle and/or the second angle may be measured relative to a planar surface of one or more layers (e.g., electroactive layers, current collectors, separators) in the electrode stack.

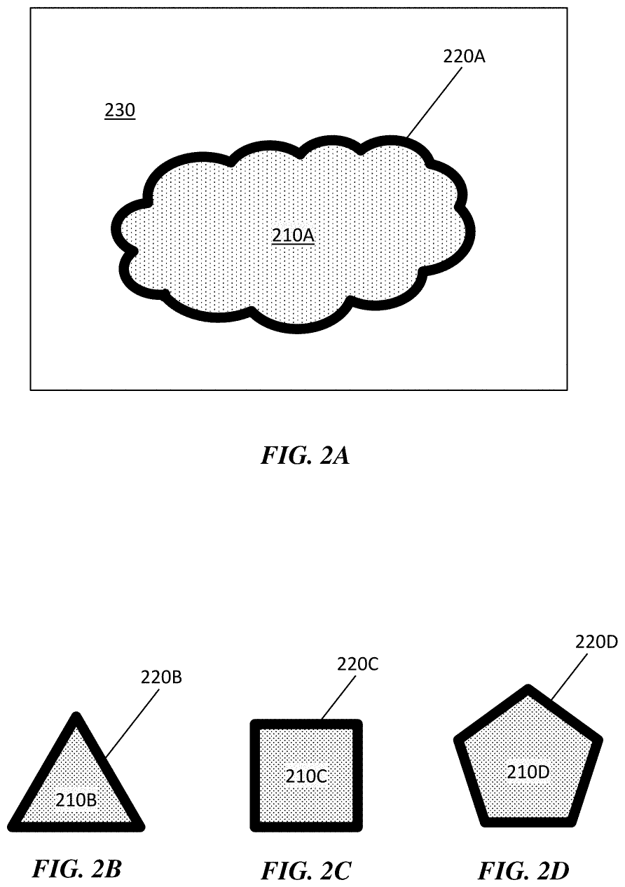

As described herein, an “edge” describes the boundary defined by the interior portion of a closed shape and the exterior of the closed shape. For example, as shown illustratively in FIG. 2A, an interior portion 210A of the irregular shape shown in the figure is bound by an edge 220A, which separates the interior portion 210A from an exterior 230. In the case of shapes that are polygonal in shape (e.g., a triangle, a square, a pentagon, a hexagon, a heptagon, and so forth), the edge may also be defined by a line segment that connects two vertices of the shape without crossing into the interior portion of the shape. For example, FIG. 2B, FIG. 2C, and FIG. 2D depict triangular, square, and pentagonal closed shapes, respectively, each having an edge 220B, 220C, and 220D containing interior portions of the shapes 210B, 210C, and 210D, respectively.

It should be noted that any terms as used herein related to shape, orientation, alignment, and/or geometric relationship of or between, for example, one or more layers, components, combinations thereof and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter. Examples of such terms related to shape, orientation, alignment, and/or geometric relationship include, but are not limited to terms descriptive of: shape—such as, round, square, circular/circle, rectangular/rectangle, triangular/triangle, cylindrical/cylinder, cone/conical, elliptical/ellipse, (n)polygonal/(n)polygon, U-shaped, line-shaped, etc.; angular orientation—such as perpendicular, orthogonal, parallel, vertical, horizontal, collinear, etc.; contour and/or trajectory—such as, plane/planar, coplanar, hemispherical, semi-hemispherical, line/linear, hyperbolic, parabolic, flat, curved, straight, arcuate, sinusoidal, tangent/tangential, etc.; arrangement—array, row, column, and the like. As one example, a fabricated article that would be described herein as being “ square” would not require such an article to have faces or sides that are perfectly planar or linear and that intersect at angles of exactly 90 degrees (indeed, such an article can only exist as a mathematical abstraction), but rather, the shape of such article should be interpreted as approximating a “ square,” as defined mathematically, to an extent typically achievable and achieved for the recited fabrication technique as would be understood by those skilled in the art or as specifically described.

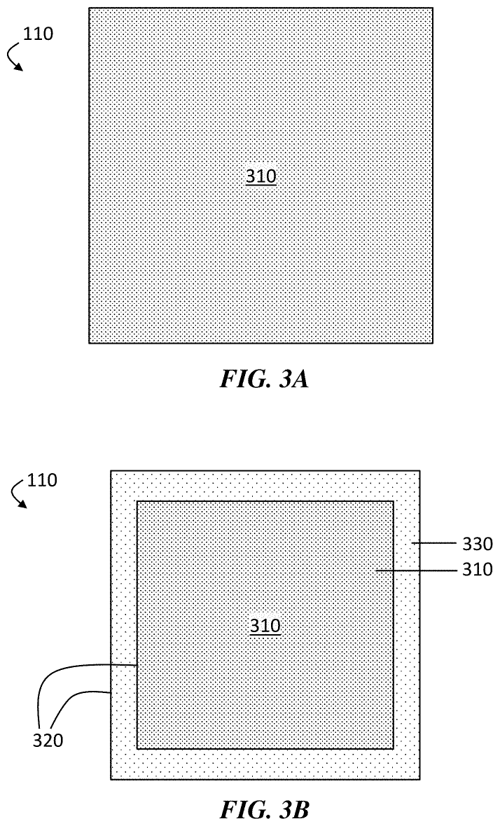

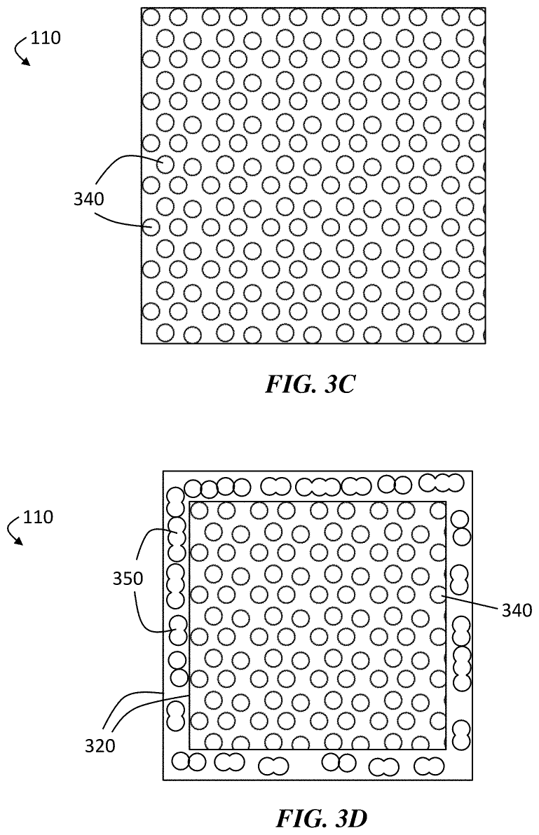

As described above, the electroactive layer may comprise a first material. For example, as shown illustratively in FIG. 3A, the electroactive layer 110 comprises a first material 310. A laser (such as laser 120) may be used to cut a shape in the electroactive layer resulting in the formation of one or more cut edges. For example, as shown illustratively in FIG. 3B, the electroactive layer 110 has been cut and is bordered by edge 320. By being cut by the laser, the first material is altered into a second material that is different from the first material in one or more physical and/or chemical properties. For example, as shown in the figure, the edge 320 comprises a second material 330, which is different than the first material 310. Details of the manner in which the first material may differ in physical and/or chemical properties from the second material are discussed below and elsewhere herein.

In some embodiments, the first material and the second material may comprise two distinct phases. That is to say, in some embodiments, the first material comprises a first phase and the second material comprises a second phase different from the first phase. The term “phase” is generally used herein to refer to a state of matter. For example, the phase can refer to a phase shown on a phase diagram. Generally, when multiple phases are present, they are distinguishable from each other, even if both are solid phases. For example, the first phase may be a crystalline phase (e.g., single crystalline, polycrystalline) and the second phase may also be a crystalline phase, but these two crystalline phases may be crystallographically distinct (i.e., distinct lattice parameters of the unit cell). As another example, the first phase may be a crystalline phase and the second phase may be an amorphous phase. However, it should be understood that other combinations of phases of the first phase and the second phase are possible. The crystallinity of a phase can be determined using x-ray diffraction techniques.

In some embodiments, the electroactive layer comprises a plurality of particles. For example, as shown illustratively in FIG. 3C, the electroactive layer 110 comprises a plurality of particles 340. Upon applying a laser (such as laser 120) to the electroactive layer comprising the plurality of particles, the electroactive layer may be cut into a shape with cut edges. The laser may also cause at least some of the particles to fuse to form fused particles at or within the edge (e.g., laser-cut edge) of the electroactive layer. By way of example, FIG. 3D shows edge 320 comprising fused particles 350 while the interior portion of the cut electroactive layer 110 comprises unfused particles 340. It is noted that while some of the particles within the edge are fused, not necessarily all of the particles within the edge are fused together.

As described above, some embodiments include an electroactive layer comprising an electroactive material. An electroactive material includes a material that may comprise an electroactive species (e.g., lithium ions), such as by intercalation of the electroactive species or by conversion reactions (e.g., oxidation-reduction reactions) of the electroactive species. In some embodiments, the electroactive material is configured to intercalate and/or deintercalate an electroactive species (e.g., a lithium-ion intercalation material).

The electroactive material may be a variety of suitable materials. In some embodiments, the electroactive material comprises a conductive carbon material, a 2-dimensional layered material, and/or a lithium intercalation compound. In some embodiments, the electroactive material is a cathode active material. In other embodiments, the electroactive material is an anode active material. Non-limiting examples of electroactive materials (e.g., cathode active materials, anode active materials) are described in more detail further below.

In some embodiments, the electroactive layer may comprise a cathode material as the electroactive material or the first material. A cathode may be fabricated comprising the electroactive layer comprising the cathode material. Suitable cathode materials for the electroactive material include, but are not limited to, one or more metal oxides, one or more intercalation materials, electroactive transition metal chalcogenides, electroactive conductive polymers, carbon-containing materials and/or combinations thereof. Other materials that are not listed below may also be used in some embodiments.

In some embodiments, the cathode active material (e.g., the first material) comprises one or more metal oxides. In some embodiments, the cathode active material is an intercalation compound comprising a lithium transition metal oxide or a lithium transition metal phosphate. Non-limiting examples include LiₓCoO₂ (e.g., Li_{1.1}CoO₂), LiₓNiO₂, LiₓMnO₂, LiₓMn₂O₄ (e.g., Li_{1.1}Co_{0.5}Mn₂O₄), LiₓCoPO₄, LiₓMnPO₄, LiCoₓNi₍₁₋ₓ₎O₂, and LiCoₓNi_{y}Mn_{(1-x-y)}O₂ (e.g., LiNi_{1/3}Mn_{1/3}Co_{1/3}O₂, LiNi_{3/5}Mn_{1/5}Co_{1/5}O₂, LiNi_{4/5}Mn_{1/10}Co_{1/10}O₂, LiNi_{1/2}Mn_{3/10}Co_{1/5}O₂). X may be greater than or equal to 0 and less than or equal to 2. X is typically greater than or equal to 1 and less than or equal to 2 when the electrochemical device is fully discharged, and less than 1 when the electrochemical device is fully charged. In some embodiments, a fully charged electrochemical device may have a value of x that is greater than or equal to 1 and less than or equal to 1.05, greater than or equal to 1 and less than or equal to 1.1, or greater than or equal to 1 and less than or equal to 1.2. Further examples include LiₓNiPO₄, where (0<x≤1), LiMnₓNi_{y}O₄ where (x+y=2) (e.g., LiMn_{1.5}Ni_{0.5}O₄), LiNiₓCo_{y}Al_{z}O₂ where (x+y+z=1), LiFePO₄, and combinations thereof. In some embodiments, the cathode active material within a cathode comprises lithium transition metal phosphates (e.g., LiFePO₄), which can, in some embodiments, be substituted with borates and/or silicates.

In some embodiments, the cathode active material (e.g., the first material) comprises a lithium intercalation compound (i.e., a compound that is capable of reversibly inserting lithium ions at lattice sites and/or interstitial sites). In some cases, the electroactive material comprises a layered oxide. A layered oxide generally refers to an oxide having a lamellar structure (e.g., a plurality of sheets, or layers, stacked upon each other). Non-limiting examples of suitable layered oxides include lithium cobalt oxide (LiCoO₂), lithium nickel oxide (LiNiO₂), and lithium manganese oxide (LiMnO₂). In some embodiments, the layered oxide is lithium nickel manganese cobalt oxide (LiNiₓMn_{y}Co_{z}O₂, also referred to as “NMC” or “NCM”). In some such embodiments, the sum of x, y, and z is 1. For example, a non-limiting example of a suitable NMC compound is LiNi_{1/3}Mn_{1/3}Co_{1/3}O₂. In some embodiments, a layered oxide may have the formula (Li₂MnO₃)ₓ(LiMO₂)₍₁₋ₓ₎ where M is one or more of Ni, Mn, and Co. For example, the layered oxide may be (Li₂MnO₃)_{0.25}(LiNi_{0.03}Co_{0.15}Mn_{0.55}O₂)_{0.75}. In some embodiments, the layered oxide is lithium nickel cobalt aluminum oxide (LiNiₓCo_{y}Al_{z}O₂, also referred to as “NCA”). In some such embodiments, the sum of x, y, and z is 1. For example, a non-limiting example of a suitable NCA compound is LiNi_{0.08}C_{0.15}Al_{0.05}O₂. In some embodiments, the electroactive material is a transition metal polyanion oxide (e.g., a compound comprising a transition metal, an oxygen, and/or an anion having a charge with an absolute value greater than 1). A non-limiting example of a suitable transition metal polyanion oxide is lithium iron phosphate (LiFePO₄, also referred to as “LFP”). Another non-limiting example of a suitable transition metal polyanion oxide is lithium manganese iron phosphate (LiMnxFe₁₋ₓPO₄, also referred to as “LMFP”). A non-limiting example of a suitable LMFP compound is LiMn_{0.8}Fe_{0.2}PO₄. In some embodiments, the electroactive material is a spinel (e.g., a compound having the structure AB₂O₄, where A can be Li, Mg, Fe, Mn, Zn, Cu, Ni, Ti, or Si, and B can be Al, Fe, Cr, Mn, or V). A non-limiting example of a suitable spinel is a lithium manganese oxide with the chemical formula LiMₓMn₂₋ₓO₄ where M is one or more of Co, Mg, Cr, Ni, Fe, Ti, and Zn. In some embodiments, x may equal 0 and the spinel may be lithium manganese oxide (LiMn₂O₄, also referred to as “LMO”). Another non-limiting example is lithium manganese nickel oxide (LiNiₓMn₂₋ₓO₄, also referred to as “LMNO”). A non-limiting example of a suitable LMNO compound is LiNi_{0.5}Mn_{1.5}O₄. In some cases, the electroactive material of the second electrode comprises Li_{1.14}Mn_{0.42}Ni_{0.25}Co_{0.29}O₂ (“HC-MNC”), lithium carbonate (Li₂CO₃), lithium carbides (e.g., Li₂C₂, Li₄C, Li₆C₂, Li₈C₃, Li₆C₃, Li₄C₃, Li₄C₅), vanadium oxides (e.g., V₂O₅, V₂O₃, V₆O₁₃), and/or vanadium phosphates (e.g., lithium vanadium phosphates, such as Li₃V₂(PO₄)₃), or any combination thereof.

In some embodiments, the cathode active material (e.g., the first material) comprises a conversion compound and the electrode comprising the electroactive material may be a lithium conversion cathode. It has been recognized that a cathode comprising a conversion compound may have a relatively large specific capacity. Without wishing to be bound by a particular theory, a relatively large specific capacity may be achieved by utilizing all possible oxidation states of a compound through a conversion reaction in which more than one electron transfer takes place per transition metal (e.g., compared to 0.1-1 electron transfer in intercalation compounds). Suitable conversion compounds include, but are not limited to, transition metal oxides (e.g., Co₃O₄), transition metal hydrides, transition metal sulfides, transition metal nitrides, and transition metal fluorides (e.g., CuF₂, FeF₂, FeF₃). A transition metal generally refers to an element whose atom has a partially filled d sub-shell (e.g., Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, Rf, Db, Sg, Bh, Hs).

In some cases, the cathode active material (e.g., the first material) may be doped with one or more dopants to alter the electrical properties (e.g., electrical conductivity) of the electroactive material. Non-limiting examples of suitable dopants include aluminum, niobium, silver, and zirconium.

In some embodiments, the cathode active material (e.g., the first material) may be modified by a surface coating comprising an oxide. Non-limiting examples of surface oxide coating materials include: MgO, Al₂O₃, SiO₂, TiO₂, ZnO₂, SnO₂, and ZrO₂. In some embodiments, such coatings may prevent direct contact between the electroactive material and the electrolyte, thereby suppressing side reactions.

In some embodiments, at least a portion of the electrode and/or electroactive layer may include a non-electroactive active material. In contrast to the electroactive material, the non-electroactive material does not comprise or is not configured to contain an electroactive species (e.g., lithium ions) and/or allow the electroactive species to pass through or across it. Accordingly, in some such embodiments, the non-electroactive material is not capable of intercalating the electroactive species nor is it capable of conversion reactions of the electroactive species. That is to say, in some embodiments, the non-electroactive material is impermeable to the electroactive species. Impermeable in the context of the non-electroactive material and the electroactive species means that the electroactive species cannot pass through or across the non-electroactive material (e.g., by diffusion, by one or more electrochemical reactions) such that the non-electroactive material acts a barrier to the electroactive species. In embodiments in which the electrode or electroactive layer comprises a binder, it should be understood that the non-electroactive material is distinct from the binder. Accordingly, in some embodiments, the non-electroactive material is a non-polymeric material (e.g., it may be an inorganic material, such as a glass, ceramic, glassy-ceramic). Non-limiting examples include nickel oxide, cobalt oxide, lithium oxide, and/or manganese oxide. Other materials may comprise the non-electroactive layer.

In some embodiments, the non-electroactive material is located at the edge of the electroactive layer and is absent from the interior portion of the electroactive layer. In some embodiments, the non-electroactive material is disposed on one or more edges of the electroactive layer as described above and elsewhere herein. For example, in FIG. 3B, the first material 310 of the electroactive layer 120 can be an electroactive material, while the second material 330 within the edge 320 can be a non-electroactive material. Other arrangements of the electroactive material and the non-electroactive material within the electroactive layer are possible as this disclosure is not so limited.

In some embodiments (but not necessarily all embodiments), the non-electroactive material is absent in an interior portion of the electroactive layer. That is to say, the non-electroactive material is present at or along the edge, but not in an interior portion of the electroactive layer .In some embodiments, the amount of non-electroactive material in an interior portion of electroactive layer is less than or equal to 10 wt %, less than or equal to 8 wt %, less than or equal to 6 wt %, less than or equal to 5 wt %, less than or equal to 3 wt %, less than or equal to 1 wt %, less than or equal to 0.01 wt %, or less. In some embodiments, the amount of non-electroactive material in an interior portion of the electroactive layer is 0 wt %. In some embodiments, the amount of non-electroactive material in an interior portion of the electroactive layer is greater than or equal to 0.01 wt %, greater than or equal to 1 wt %, greater than or equal to 3 wt %, greater than or equal to 5 wt %, greater than or equal to 6 wt %, greater than or equal to 8 wt %, or greater than or equal to 10 wt %. Combinations of the above-reference ranges are also possible (e.g., less than or equal to 1 wt % and greater than or equal to 0.01 wt %). Other ranges are possible.

The electroactive layer may be any suitable thickness. In some embodiments, the electroactive layer has a thickness of greater than or equal to 10 microns, greater than or equal to 20 microns, greater than or equal to 30 microns, greater than or equal to 40 microns, greater than or equal to 50 microns, greater than or equal to 75 microns, greater than or equal to 100 microns, greater than or equal to 150 microns, or more. In some embodiments, the electroactive layer has a thickness of less than or equal to 150 microns, less than or equal to 100 microns, less than or equal to 75 microns, less than or equal to 50 microns, less than or equal to 40 microns less than or equal to 30 microns, less than or equal to 20 microns, less than or equal to 10 microns, or less. Combinations of the above-referenced ranges are also possible (e.g., greater than or equal to 50 microns and less than or equal to 150 microns). Other ranges are possible.

As mentioned above, the electroactive layer may include a first material (e.g., an electroactive material) that is single crystalline (e.g., a single crystalline phase). As used herein, “single crystalline” describes a material in which the crystal lattice of the material is continuous and unbroken up to the edges of the material and contains no grain boundaries. In some embodiments, the first material is polycrystalline. As used herein, “polycrystalline” refers to a material having many crystallites or grains of varying sizes and orientations containing single crystalline material within the crystallites and where the crystallites are separated by grain boundaries. The first material may be located at an interior portion of the electroactive layer and may be more crystalline than a second material located at one or more edges of the electroactive layer. For example, when the first material is single crystalline, the second material can be polycrystalline or amorphous. When the first material is polycrystalline, the second material may be amorphous. However, it should be noted that in some cases, the first material may be polycrystalline, and the second material may also be polycrystalline, albeit less crystalline than the first material. The crystallinity (e.g., the degree of crystallinity) of a material can be determined via x-ray diffractometry (e.g., powder x-ray diffractometry).

As described above, the electroactive layer can also comprise a second material (e.g., a non-electroactive material). The laser may be used to modify or alter (e.g., physically alter, chemically alter) the first material so as to form the second material. In some embodiments, the laser alters the first, crystalline material into a second, less crystalline material, such as an amorphous material (e.g., an amorphous phase). That is to say, in some embodiments, the second material is polycrystalline or amorphous, as noted above. As used herein, “amorphous” describes a material that lacks the long-range order that is characteristic of a crystal. In some embodiments, altering of the first material into the second material occurs during and/or after applying the laser. The second material may have a composition (e.g., a chemical formula) similar or substantially identical to the first material but may lack the crystallinity of the first material. However, in other embodiments, the second material has a different composition than the first material. In some embodiments the first material and/or the second material comprises a ceramic material. Non-limiting examples of ceramic materials are described in more detail elsewhere herein.

The first material may have any suitable thickness. In some embodiments, the first material has a thickness of greater than or equal to 10 microns, greater than or equal to 20 microns, greater than or equal to 30 microns, greater than or equal to 40 microns, greater than or equal to 50 microns, greater than or equal to 75 microns, greater than or equal to 100 microns, greater than or equal to 150 microns, or more. In some embodiments, the first material has a thickness of less than or equal to 150 microns, less than or equal to 100 microns, less than or equal to 75 microns, less than or equal to 50 microns, less than or equal to 40 microns less than or equal to 30 microns, less than or equal to 20 microns, less than or equal to 10 microns, or less. Combinations of the above-referenced ranges are also possible (e.g., greater than or equal to 50 microns and less than or equal to 150 microns). Other ranges are possible. The thickness of a material layer can be determined by microscopy techniques, for example scanning electron microscopy SEM.

The second material may have any suitable thickness. In some embodiments, the second material has a thickness of greater than or equal to 10 microns, greater than or equal to 20 microns, greater than or equal to 30 microns, greater than or equal to 40 microns, greater than or equal to 50 microns, greater than or equal to 75 microns, greater than or equal to 100 microns, greater than or equal to 150 microns, or more. In some embodiments, the second material has a thickness of less than or equal to 150 microns, less than or equal to 100 microns, less than or equal to 75 microns, less than or equal to 50 microns, less than or equal to 40 microns less than or equal to 30 microns, less than or equal to 20 microns, less than or equal to 10 microns, or less. Combinations of the above-referenced ranges are also possible (e.g., greater than or equal to 50 microns and less than or equal to 150 microns). Other ranges are possible.

In some embodiments, the first material and the second material may have a particular ratio of dimensions (e.g., longest cross-sectional dimension, a thickness). In some embodiments, the ratio of dimensions of the first material to the second material is greater than or equal to 1:1, greater than or equal to 1.5:1, greater than or equal to 2:1, greater than or equal to 2.5:1, greater than or equal to 3:1, greater than or equal to 4:1, or greater than or equal to 5:1. In some embodiments, the ratio of dimensions of the first material to the second material is less than or equal to 5:1, less than or equal to 4:1, less than or equal to 3:1, less than or equal to 2.5:1, less than or equal to 2:1, less than or equal to 1.5:1, or less than or equal to 1:1. Combinations of the above-referenced ranges are also possible (e.g., greater than or equal to 1:1 and less than or equal to 5:1). Other ranges are possible. The ratio of dimensions of the first material and the second material may also be measured using SEM. For example, using FIG. 3B as a non-limiting example, the longest cross-sectional dimension of first material 310 contained by the edge 320 can be measured and the dimension of the second material 330 within the edge 320 can also be measured and a ratio of these to dimensions can then be determined.

In some embodiments, the electroactive layer comprises a plurality of particles, which was described above in relation to FIGS. 3C-3D. The plurality of particles may be unfused or fused particles. The terms “fuse,” “fused,” and “fusion” are given their typical meaning in the art and generally refers to the physical joining of two or more objects (e.g., particles) such that they form a single object. For example, in some cases, the volume occupied by a single particle (e.g., the entire volume within the outer surface of the particle) prior to fusion is substantially less than or equal to half the volume occupied by two fused particles. Particle fusion can be determined using microscopy techniques, such as scanning electron microscopy (SEM).

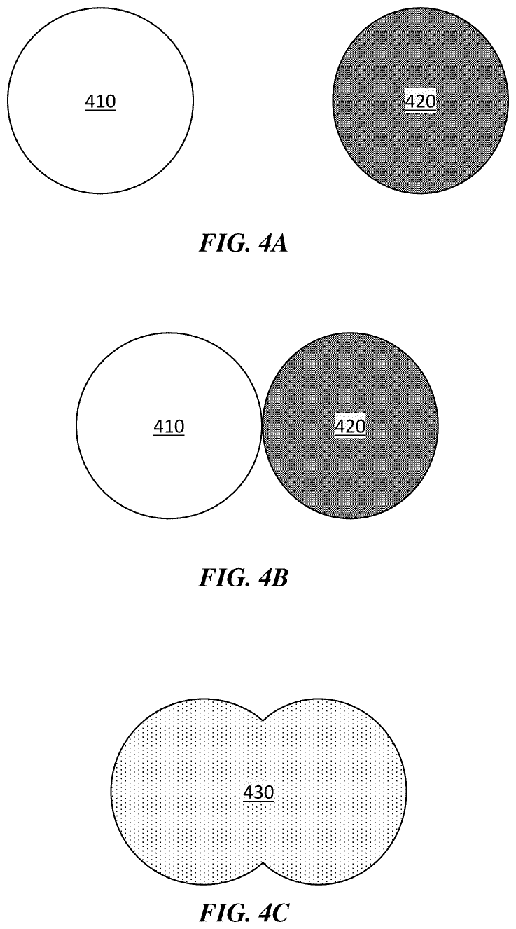

By way of example, FIGS. 4A-4C show unfused and fused particles. In FIG. 4A, a first (unfused) particle 410 and a second (unfused) particle 420 are visibly distinct from each other. In FIG. 4B, the first particle 410 and the second particle 420 are in contact at the surface of each particle (e.g., sintered). And in FIG. 4C, the first and second particle are fused together into fused particle 430 such that the interior portions of the originally unfused particles are now at least partially merged into one particle with no distinct interface between the fused particles. While FIGS. 4A-4C show two particles, it should be understood that fusion of particles can include two or more particles.

In some embodiments, at least some the fused particles comprise joined interior portions relative to unfused particles. For example, FIG. 4C shows two particles that have been fused, where the interior portions of the particles are joined together in contrast to the particles in FIG. 4B, where first particle 410 and second particle 420 are in contact with one another, but where their interior portions have not been joined.

In some embodiments, the fusion of particles (i.e., fused particles) may result in forming one or more bonds between the unfused particles so as to bond (e.g., chemically bond) one or more portions of the fused particles together.

The plurality of particles may comprise an electroactive material. For example, in some embodiments, the plurality of unfused particles comprises an electroactive material. In some cases, the plurality of particles (e.g., unfused particles) comprises an electroactive material configured to intercalate and/or deintercalate an electroactive species. However, in some cases, at least a portion of the plurality of particles comprises a non-electroactive material. For example, in some embodiments, at least a portion of the fused particles comprises a non-electroactive material. In such embodiments, the fused particles may be impermeable to an electroactive species (e.g., lithium ions).

The plurality of particles (e.g., unfused particles, fused particles) may have an average largest cross-sectional dimension (e.g., a diameter). In some embodiments, the average largest cross-sectional dimension of the plurality of particles is less than or equal to 20 microns, less than or equal to 15 microns, less than or equal to 10 microns, less than or equal to 5 microns, less than or equal to 3 microns, less or equal to 2 microns, less than or equal to 1.5 microns, less than or equal to 1 micron, less than or equal to 0.75 microns, or less than or equal to 0.5 microns. In some embodiments, the average largest cross-sectional dimension of the plurality of particles is greater than or equal to 0.5 microns, greater than or equal to 0.75 microns, greater than or equal to 1 micron, greater than or equal to 1.5 microns, greater than or equal to 2 microns, greater than or equal to 3 microns, greater than or equal to 5 microns, greater than or equal to 10 microns, greater than or equal to 15 microns, or greater than or equal to 20 microns. Combinations of the above-referenced ranges are also possible (e.g., a largest cross-sectional dimension of less than 10 microns and greater than or equal to 1 micron). Other ranges are possible. In some cases in which more than one particle type is included (e.g., fused and unfused particles), each particle type may have a value of the average largest cross-sectional dimension in one or more of the above-referenced ranges. The average largest cross-sectional dimension may be determined using microscopy techniques, such as SEM.

As described above, an electroactive material may be configured to include (e.g., intercalate/deintercalate) an electroactive species. In some embodiments, the electroactive species comprises a lithium species, such as lithium atoms, lithium ions (i.e., lithium cations), or lithium metal. However, other electroactive species are possible, such as sodium, potassium, and magnesium, without limitation.

In some embodiments, the electroactive layer may also include a binder. In some cases, the binder may provide a matrix within the electroactive layer to hold components of the layer (e.g., the electroactive material, the first material, at least some of the plurality of particles) in proximity to one another and may also provide mechanical strength to the layer. In some embodiments, the binder may comprise a polymeric binder (e.g., an organic polymeric binder). The polymeric binder can be any asuitable polymer provided that the polymer provides adequate mechanical support to the electroactive layer or the electrode. In some embodiments, the polymeric binder comprises a polyvinylidene difluoride (PVDF) polymer. However, other polymeric binders are possible. Non-limiting examples of other polymeric binders include polyether sulfone, polyether ether sulfone, polyvinyl alcohol, polyvinyl acetate, and polybenzimidazole. Additional non-limiting examples of polymeric binders include a poly(vinylidene fluoride copolymer) such as a copolymer with hexafluorophosphate, a poly(styrene)-poly(butadiene) copolymer, a poly(styrene)-poly(butadiene) rubber, carboxymethyl cellulose, and poly(acrylic acid). Other polymeric binders are possible.

In some embodiments, the weight percentage of binder in the electroactive layer is greater than or equal to 1 wt %, greater than or equal to 2 wt %, greater than or equal to 3 wt %, greater than or equal to 4 wt %, greater than or equal to 5 wt %, greater than or equal to 6 wt %, greater than or equal to 7 wt %, greater than or equal to 8 wt %, greater than or equal to 9 wt %, greater than or equal to 10 wt %, or more. In some embodiments, the wt % of binder in the electroactive layer is less than or equal to 10 wt %, less than or equal to 9 wt %, less than or equal to 8 wt %, less than or equal to 7 wt %, less than or equal to 6 wt %, less than or equal to 5 wt %, less than or equal to 4 wt %, less than or equal to 3 wt %, less than or equal to 2 wt %, less than or equal to 1 wt %, or less. Combinations of the above-referenced ranges are also possible (e.g., greater than or equal to 1 wt % and less than or equal to 3 wt %). Other ranges are possible.

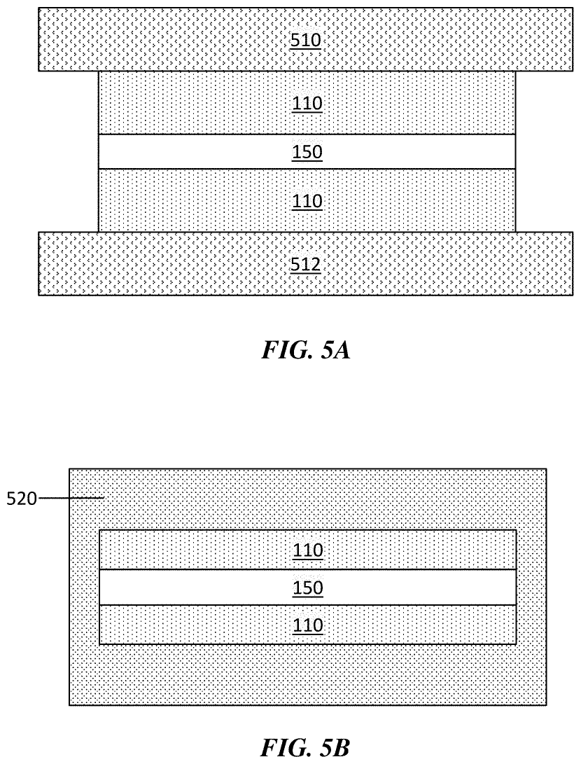

The laser cutting described herein may also be used to provide an “envelope”-like structure that surrounds an electroactive layer and/or a current collector. For example, FIG. 5A illustratively shows a cross section of a current collector 150 with an electroactive layer 110 disposed on the front surface and the back surface of the current collector 150. A first separator 510 is adjacent to a front surface of the electroactive layer 110 and a second separator 512 is adjacent to a back surface of the electroactive layer 110. A laser (such as laser 120) may cut the first separator, the electroactive layer, the current collector, and the second separator, such that the first separator and the second separator surround (all, or partially) a perimeter of a cross section of the electroactive layer. For example, as shown illustratively in FIG. 5B, the first separator and the second separator now form a separator envelope 520 in conformal contact with the electroactive layer 110. In some embodiments, the laser can cut the first separator and the second separator in addition to melting and/or sealing the first and second separator together to form the separator envelope. Advantageously, the separator envelope can prevent electroactive species (e.g., lithium) from entering the edges of the electroactive layer and block the formation of dendrites (e.g., lithium metal dendrites), specifically along the edges of the electroactive layer, but in some embodiments also in other locations along or within the interior of the electroactive layer.

In some embodiments, the separator(s) (e.g., the first separator and/or the second separator) surrounds a perimeter of the cross section of the electroactive layer. In some embodiments, the separator(s) (e.g., first separator and/or the second separator) surrounds greater than or equal 50%, greater than or equal to 60%, greater than or equal to 70% , greater than or equal to 80%, greater than or equal to 90%, greater than or equal to 95%, or greater than or equal to 99% of the perimeter of the cross section of the electroactive layer. In some embodiments, the separator(s) (e.g., first separator and/or the second separator) surrounds less than or equal to 99%, less than or equal to 95%, less than or equal to 90%, less than or equal to 80%, less than or equal to 70%, less than or equal to 60%, or less than or equal to 50% of the perimeter of the cross section of the electroactive layer. Combinations of the above-referenced ranges are also possible (e.g., greater than or equal to 50% and less than or equal to 99%). Other ranges are possible. In some cases, the separator(s) (e.g., first separator and/or the second separator) may surround a cross section of one or more electroactive layers, and, in some such cases, may also surround a current collector in which the one or more electroactive layers are disposed on in keeping with the above-referenced ranges.

In some (but not necessarily all) embodiments, the separator(s) (e.g., first separator and the second separator) surround the entirety (i.e., 100%) of the perimeter of the cross section of the electroactive layer. In some such embodiments, the separator(s) (e.g., first separator and the second separator) are in conformal contact with the perimeter and may be joined (e.g., melted, sealed) together, such as by action of the laser cutting.

The electrodes described herein may be used in an electrochemical cell. Some of various components of electrochemical cells are described below.

In some embodiments, an electrochemical cell includes a cathode, which may comprise a laser-cut electroactive layer as described herein. The electroactive layer may comprise an electroactive material, such as the cathode active materials as described above. Additional cathode active materials are described below.

In some embodiments, the electroactive material (e.g., the first material, cathode active material) or at least a portion of the plurality of particles comprise a composition as in formula (I):

Li₂ₓS_{x+w+5z}M_{y}P_{2z} (I),

where x is 8-16, y is 0.1-6, w is 0.1-15, z is 0.1-3, and M is selected from the group consisting of Lanthanides, Group 3, Group 4, Group 8, Group 12, Group 13, and Group 14 atoms, and combinations thereof.

In some embodiments, the electroactive material (e.g., the first material) or at least a portion of the plurality of particles comprise a composition as in formula (I) and x is 8-16, 8-12, 10-12, 10-14, or 12-16. In some embodiments x is 8 or greater, 8.5 or greater, 9 or greater, 9.5 or greater, 10 or greater, 10.5 or greater, 11 or greater, 11.5 or greater, 12 or greater, 12.5 or greater, 13 or greater, 13.5 or greater, 14 or greater, 14.5 or greater, 15 or greater, or 15.5 or greater. In some embodiments, x is less than or equal to 16, less than or equal to 15.5, less than or equal to 15, less than or equal to 14.5, less than or equal to 14, less than or equal to 13.5, less than or equal to 13, less than or equal to 12.5, less than or equal to 12, less than or equal to 11.5, less than or equal to 11, less than or equal to 10.5, less than or equal to 10, less than or equal to 9.5, or less than or equal to 9. Combinations of the above referenced ranges are also possible (e.g., greater than or equal to 8 and less than or equal to 16, greater than or equal to 10 and less than or equal to 12). Other ranges are also possible. In some embodiments, x is 10. In some embodiments, x is 12.

In some embodiments, the electroactive material (e.g., the first material) or at least a portion of the plurality of particles comprise a composition as in formula (I) and y is 0.1-6, 0.1-1, 0.1-3, 0.1-4.5, 0.1-6, 0.8-2, 1-4, 2-4.5, 3-6 or 1-6. For example, in some embodiments, y is 1. In some embodiments, y is greater than or equal to 0.1, greater than or equal to 0.2, greater than or equal to 0.4, greater than or equal to 0.5, greater than or equal to 0.6, greater than or equal to 0.8, greater than or equal to 1, greater than or equal to 1.2, greater than or equal to 1.4, greater than or equal to 1.5, greater than or equal to 1.6, greater than or equal to 1.8, greater than or equal to 2.0, greater than or equal to 2.2, greater than or equal to 2.4, greater than or equal to 2.5, greater than or equal to 2.6, greater than or equal to 2.8, greater than or equal to 3.0, greater than or equal to 3.5, greater than or equal to 4.0, greater than or equal to 4.5, greater than or equal to 5.0, or greater than or equal to 5.5. In some embodiments, y is less than or equal to 6, less than or equal to 5.5, less than or equal to 5.0, less than or equal to 4.5, less than or equal to 4.0, less than or equal to 3.5, less than or equal to 3.0, less than or equal to 2.8, less than or equal to 2.6, less than or equal to 2.5, less than or equal to 2.4, less than or equal to 2.2, less than or equal to 2.0, less than or equal to 1.8, less than or equal to 1.6, less than or equal to 1.5, less than or equal to 1.4, less than or equal to 1.2, less than or equal to 1.0, less than or equal to 0.8, less than or equal to 0.6, less than or equal to 0.5, less than or equal to 0.4, or less than or equal to 0.2. Combinations of the above-referenced ranges are also possible (e.g., greater than or equal to 0.1 and less than or equal to 6.0, greater than or equal to 1 and less than or equal to 6, greater than or equal to 1 and less than or equal to 3, greater than or equal to 0.1 and less than or equal to 4.5, greater than or equal to 1.0 and less than or equal to 2.0). Other ranges are also possible. In embodiments in which a compound of formula (I) includes more than one M, the total y may have a value in one or more of the above-referenced ranges and in some embodiments may be in the range of 0.1-6.

In some embodiments, the electroactive material (e.g., the first material) or at least a portion of the plurality particles comprise a composition as in formula (I) and z is 0.1-3, 0.1-1, 0.8-2, or 1-3. For example, in some embodiments, z is 1. In some embodiments, z is greater than or equal to 0.1, greater than or equal to 0.2, greater than or equal to 0.4, greater than or equal to 0.5, greater than or equal to 0.6, greater than or equal to 0.8, greater than or equal to 1, greater than or equal to 1.2, greater than or equal to 1.4, greater than or equal to 1.5, greater than or equal to 1.6, greater than or equal to 1.8, greater than or equal to 2.0, greater than or equal to 2.2, greater than or equal to 2.4, greater than or equal to 2.5, greater than or equal to 2.6, or greater than or equal to 2.8. In some embodiments, z is less than or equal to 3.0, less than or equal to 2.8, less than or equal to 2.6, less than or equal to 2.5, less than or equal to 2.4, less than or equal to 2.2, less than or equal to 2.0, less than or equal to 1.8, less than or equal to 1.6, less than or equal to 1.5, less than or equal to 1.4, less than or equal to 1.2, less than or equal to 1.0, less than or equal to 0.8, less than or equal to 0.6, less than or equal to 0.5, less than or equal to 0.4, or less than or equal to 0.2. Combinations of the above-referenced ranges are also possible (e.g., greater than or equal to 0.1 and less than or equal to 3.0, greater than or equal to 1.0 and less than or equal to 2.0). Other ranges are also possible.

In some embodiments, the ratio of y to z is greater than or equal to 0.03, greater than or equal to 0.1, greater than or equal to 0.25, greater than or equal to 0.5, greater than or equal to 0.75, greater than or equal to 1, greater than or equal to 2, greater than or equal to 4, greater than or equal to 8, greater than or equal to 10, greater than or equal to 15, greater than or equal to 20, greater than or equal to 25, greater than or equal to 30, greater than or equal to 40, greater than or equal to 45, or greater than or equal to 50. In some embodiments, the ratio of y to z is less than or equal to 60, less than or equal to 50, less than or equal to 45, less than or equal to 40, less than or equal to 30, less than or equal to 25, less than or equal to 20, less than or equal to 15, less than or equal to 10, less than or equal to 8, less than or equal to 4, less than or equal to 3, less than or equal to 2, less than or equal to 1, less than or equal to 0.75, less than or equal to 0.5, less than or equal to 0.25, or less than or equal to 0.1. Combinations of the above-referenced ranges are also possible (e.g., a ratio of y to z of greater than or equal to 0.1 and less than or equal to 60, a ratio of y to z of greater than or equal to 0.1 and less than or equal to 10, greater than or equal to 0.25 and less than or equal to 4, or greater than or equal to 0.75 and less than or equal to 2). In some embodiments, the ratio of y to z is 1.

In some embodiments, the electroactive material (e.g., the first material) or at least a portion of the plurality particles comprise a composition as in formula (I) and w is 0.1-15, 0.1-1, 0.8-2, 1-3, 1.5-3.5, 2-4, 2.5-5, 3-6, 4-8, 6-10, 8-12, or 10-15. For example, in some embodiments, w is 1. In some cases, w may be 1.5. In some embodiments, w is 2. In some embodiments, w is greater than or equal to 0.1, greater than or equal to 0.2, greater than or equal to 0.4, greater than or equal to 0.5, greater than or equal to 0.6, greater than or equal to 0.8, greater than or equal to 1, greater than or equal to 1.5, greater than or equal to 2, greater than or equal to 2.5, greater than or equal to 3, greater than or equal to 4, greater than or equal to 6, greater than or equal to 8, greater than or equal to 10, greater than or equal to 12, or greater than or equal to 14. In some embodiments, w is less than or equal to 15, less than or equal to 14, less than or equal to 12, less than or equal to 10, less than or equal to 8, less than or equal to 6, less than or equal to 4, less than or equal to 3, less than or equal to 2.5, less than or equal to 2, less than or equal to 1.5, less than or equal to 1, less than or equal to 0.8, less than or equal to 0.6, less than or equal to 0.5, less than or equal to 0.4, or less than or equal to 0.2. Combinations of the above-referenced ranges are also possible (e.g., greater than or equal to 0.1 and less than or equal to 15, greater than or equal to 1.0 and less than or equal to 3.0). Other ranges are also possible.

In an exemplary embodiment, the electroactive material (e.g., the first material) or at least a portion of the plurality particles comprise a composition as in Lii6SisMP2. In another exemplary embodiment, the electroactive material or at least a portion of the plurality particles comprise a composition as in Li₂₀Si₇MP₂. In yet another exemplary embodiment, the electroactive material or at least a portion of the plurality particles comprise a composition as in Li₂₄S₁₉MP₂. For example, in some embodiments, the electroactive material or at least a portion of the plurality particles comprise a composition according to a formula selected from the group consisting of Lii6SisMP2, Li₂OS₁₇MP₂ and Li₂₄S₁₉MP₂.

In some embodiments, w is equal to y. In some embodiments, w is equal to 1.5y. In other embodiments, w is equal to 2y. In yet other embodiments, w is equal to 2.5y. In yet further embodiments, w is equal to 3y. Without wishing to be bound by theory, those skilled in the art would understand that the value of w may, in some cases, depend upon the valency of M. For example, in some embodiments, M is a tetravalent atom, w is 2y, and y is 0.1-6. In some embodiments, M is a trivalent atom, w is 1.5y, and y is 0.1-6. In some embodiments, M is a bivalent atom, w is equal to y, and y is 0.1-6. Other valences and values for w are also possible.

In some embodiments, the electroactive material (e.g., the first material) or at least a portion of the plurality particles comprise a composition as in formula (I) and M is tetravalent, x is 8-16, y is 0.1-6, w is 2y, and z is 0.1-3. In some such embodiments, the electroactive material or at least a portion of the plurality particles comprise a composition as in formula (II):

Li₂ₓS_{x+2y+5z}M_{y}P_{2z} (II),

where x is 8-16, y is 0.1-6, z is 0.1-3, and M is tetravalent and selected from the group consisting of Lanthanides, Group 4, Group 8, Group 12, and Group 14 atoms, and combinations thereof. In an exemplary embodiment, M is Si, x is 10.5, y is 1, and z is 1 such that the compound of formula (II) is Li₂₁S_{17.5}SiP₂.

In some embodiments, the electroactive material (e.g., the first material) or at least a portion of the plurality particles comprise a composition as in formula (I) and M is trivalent, x is 8-16, y is 1, w is 1.5y, and z is 1. In some such embodiments, the electroactive material or at least a portion of the plurality particles comprise a composition as in formula (III):

Li₂ₓS_{x+1.5y+5z}M_{y}P_{2z} (III),

where x is 8-16, y is 0.1-6, z is 0.1-3, and M is trivalent and selected from the group consisting of Lanthanides, Group 3, Group 4, Group 8, Group 12, Group 13, and Group 14 atoms, and combinations thereof. In an exemplary embodiment, M is Ga, x is 10.5, y is 1, and z is 1 such that the compound of formula (III) is Li₂₁S_{17.5}SiP₂.

In some embodiments, M is a Group 4 (i.e., IUPAC Group 4) atom such as zirconium. In some embodiments, M is a Group 8 (i.e., IUPAC Group 8) atom such as iron. In some embodiments, M is a Group 12 (i.e., IUPAC Group 12) atom such as zinc. In some embodiments, M is a Group 13 (i.e., IUPAC Group 13) atom such as aluminum. In some embodiments, M is a Group 14 (i.e., IUPAC Group 14) atom such as silicon, germanium, or tin. In some cases, M may be selected from the groups consisting of Lanthanides, Group 3, Group 4, Group 8, Group 12, Group 13, and/or Group 14 atoms. For example, in some embodiments, M may be selected from silicon, tin, germanium, zinc, iron, zirconium, aluminum, and combinations thereof. In some embodiments, M is selected from silicon, germanium, aluminum, iron and zinc.

In some cases, M may be a combination of two or more atoms selected from the groups consisting of Lanthanides, Group 3, Group 4, Group 8, Group 12, Group 13, and Group 14 atoms. That is, in some embodiments in which M includes more than one atom, each atom (i.e., each atom M) may be independently selected from the group consisting of Lanthanides, Group 3, Group 4, Group 8, Group 12, Group 13, and Group 14 atoms. In some embodiments, M is a single atom. In some embodiments, M is a combination of two atoms. In other embodiments, M is a combination of three atoms. In some embodiments, M is a combination of four atoms. In some embodiments, M may be a combination of one or more monovalent atoms, one or more bivalent atoms, one or more trivalent atoms, and/or one or more tetravalent atoms selected from the groups consisting of Lanthanides, Group 3, Group 4, Group 8, Group 12, Group 13, and Group 14 atoms.

In such embodiments, the stoichiometric ratio of each atom in M may be such that the total amount of atoms present in M is y and is 0.1-6, or any other suitable range described herein for y. For example, in some embodiments, M is a combination of two atoms such that the total amount of the two atoms present in M is y and is 0.1-6. In some embodiments, each atom is present in M in substantially the same amount and the total amount of atoms present in M is y and within the range 0.1-6, or any other suitable range described herein for y. In other embodiments, each atom may be present in M in different amounts and the total amount of atoms present in M is y and within the range 0.1-6, or any other suitable range described herein for y. In an exemplary embodiment, the electroactive material (e.g., the first material) or at least a portion of the plurality particles comprise a composition as in formula (I) and each atom in M is either silicon or germanium and y is 0.1-6. For example, in such an embodiment, each atom in M may be either silicon or germanium, each present in substantially the same amount, and y is 1 since M_{y} is Si_{0.5}Ge_{0.5.} In another exemplary embodiment, the electroactive material or at least a portion of the plurality particles comprise a composition as in formula (I) and each atom in M may be either silicon or germanium, each atom present in different amounts such that M_{y} is Si_{y-p}Geₚ, where p is between 0 and y (e.g., y is 1 and p is 0.25 or 0.75). Other ranges and combinations are also possible. Those skilled in the art would understand that the value and ranges of y, in some embodiments, may depend on the valences of M as a combination of two or more atoms, and would be capable of selecting and/or determining y based upon the teachings of this specification. As noted above, in embodiments in which a compound of formula (I) includes more than one atom in M, the total y may be in the range of 0.1-6.

In an exemplary embodiment, M is silicon. For example, in some embodiments, the electroactive material (e.g., the first material) or at least a portion of the plurality particles comprise Li₂ₓS_{x+w+5z}Si_{y}P_{2z}, where x is greater than or equal to 8 and less than or equal to 16, y is greater than or equal to 0.1 and less than or equal to 3, w is equal to 2y, and z is greater than or equal to 0.1 and less than or equal to 3. Each x, y and z may independently be chosen from the values and ranges of x, y and z described above, respectively. For example, in one particular embodiment, x is 10, y is 1, and z is 1, and the electroactive material or at least a portion of the plurality particles comprise Li₂₀S₁₇SiP₂. In some embodiments, x is 10.5, y is 1, and z is 1, and the electroactive material or at least a portion of the plurality particles comprise Li₂₁S_{17.5}SiP₂. In some embodiments, x is 11, y is 1, and z is 1, and the electroactive material or at least a portion of the plurality particles comprise Li₂₂S₁₈SiP₂. In some embodiments, x is 12, y is 1, and z is 1, and the electroactive material or at least a portion of the plurality particles comprise Li₂₄S₁₉SiP₂. In some cases, x is 14, y is 1, and z is 1, and the electroactive material or at least a portion of the plurality particles comprise Li₂₈S₂₁SiP₂.

It should be appreciated that while some of the above description herein relates to the electroactive material (e.g., the first material) or at least a portion of the plurality particles where y is 1, z is 1, w is 2y, and comprises silicon, other combinations of values for w, x, y, and z and elements for M are also possible. For example, in some cases, M is Ge and the ceramic particles may comprise Li₂ₓS_{x+w+5z}Ge_{y}P_{2z}, where x is greater than or equal to 8 and less than or equal to 16, y is greater than or equal to 0.1 and less than or equal to 3, w is equal to 2y, and z is greater than or equal to 0.1 and less than or equal to 3. Each w, x, y and z may independently be chosen from the values and ranges of w, x, y and z described above, respectively. For example, in one particular embodiment, w is 2, x is 10, y is 1, and z is 1, and the electroactive material or at least a portion of the plurality particles comprise Li₂₀S₁₇GeP₂. In some embodiments, w is 2, x is 12, y is 1, and z is 1, and the electroactive material or at least a portion of the plurality particles comprise Li₂₄S₁₉GeP₂. In some cases, w is 2, x is 14, y is 1, and z is 1, and the electroactive material or at least a portion of the plurality particles comprise Li₂₈S₂₁GeP₂. Other stoichiometric ratios, as described above, are also possible.

In some embodiments, M is Sn and the electroactive material (e.g., the first material) or at least a portion of the plurality particles comprise may comprise Li₂ₓS_{x+w+5z}Sn_{y}P_{2z}, where x is greater than or equal to 8 and less than or equal to 16, y is greater than or equal to 0.1 and less than or equal to 3, w is equal to 2y, and z is greater than or equal to 0.1 and less than or equal to 3. Each w, x, y and z may independently be chosen from the values and ranges of w, x, y and z described above, respectively. For example, in one particular embodiment, w is 2, x is 10, y is 1, and z is 1, and the electroactive material or at least a portion of the plurality particles comprise Li2oS 17SnP2. In some embodiments, w is 2, x is 12, y is 1, and z is 1, and the electroactive material or at least a portion of the plurality particles comprise Li₂₄S₁₉SnP₂. In some cases, w is 2, x is 14, y is 1, and z is 1, and the electroactive material or at least a portion of the plurality particles comprise Li₂₈S₂₁SnP₂. Other stoichiometric ratios, as described above, are also possible.

In some embodiments, the electroactive material (e.g., the first material) or at least a portion of the plurality particles comprise glass and/or a glassy-ceramic material. In some embodiments, the electroactive material or at least a portion of the plurality particles comprise lithium-based sulfides and/or oxides. In some embodiments, the electroactive material or at least a portion of the plurality of particles comprise Li₇La₃Zr₂O₁₂ (LLZO), Li₂₂SiP₂S₁₈, antiperovskite, beta-alumina, sulfide glass, oxide glass, lithium phosphorus oxinitride, Li replaceable NASICON ceramic, Li_{1+x+y}AlₓTi₂₋ₓSi_{y}P_{3-y}O₁₂ (where x is between 0 and 2 and y is between 0 and 1.25). Li₂O—Al₂O₃—SiO₂-P₂O₅—TiO₂—GeO₂, Li₂O—Al₂O₃—SiO₂—P₂O₅—TiO₂, and/or lithium borosilicate glass. The electroactive material or at least a portion of the plurality particles may be crystalline, amorphous, or partially crystalline and partially amorphous.

Electrochemical cells may also include an anode comprising an electroactive material (e.g., the first material) that is an anode active material. In some cases, the anode may be prepared by laser cutting as described herein, by using the anode active material as the electroactive material, for example, disposed on a current collector. The anode active material may comprise a variety of suitable materials. In some embodiments, the anode active material comprises lithium (e.g., lithium metal, a layer of lithium metal), such as lithium foil, lithium deposited onto a conductive substrate or onto a non-conductive substrate (e.g., a release layer), vacuum-deposited lithium metal, and lithium alloys (e.g., lithium-aluminum alloys and lithium-tin alloys). Lithium can be provided as one film or as several films, optionally separated. Suitable lithium alloys for use in the aspects described herein can include alloys of lithium and aluminum, magnesium, silicon, indium, and/or tin.

In some cases, the lithium metal/lithium metal alloy may be present during only a portion of charge/discharge cycles. For example, the cell can be constructed without any lithium metal/lithium metal alloy on an anode current collector, and the lithium metal/lithium metal alloy may subsequently be deposited on the anode current collector during a charging step. In some embodiments, lithium may be completely depleted after discharging such that lithium is present during only a portion of the charge/discharge cycle.

In some embodiments, the anode active material comprises greater than or equal to 50 wt % lithium, greater than or equal to 75 wt % lithium, greater than or equal to 80 wt % lithium, greater than or equal to 90 wt % lithium, greater than or equal to 95 wt % lithium, greater than or equal to 99 wt % lithium, or more. In some embodiments, the anode active material comprises less than or equal to 99 wt % lithium, less than or equal to 95 wt % lithium, less than or equal to 90 wt % lithium, less than or equal to 80 wt % lithium, less than or equal to 75 wt % lithium, less than or equal to 50 wt % lithium, or less. Combinations of the above-reference ranges are also possible (e.g., greater than or equal to 90 wt % lithium and less than or equal to 99 wt % lithium). Other ranges are possible.

In some embodiments, the anode active material is a material from which lithium ions are liberated during discharge and into which the lithium ions are integrated (e.g., intercalated) during charge. In some embodiments, the anode active material or the electroactive material comprises a lithium intercalation compound (i.e., a compound that is capable of reversibly inserting lithium ions at lattice sites and/or interstitial sites). In some embodiments, the anode active material comprises carbon. In some cases, the anode active material is or comprises a graphitic material (e.g., graphite). A graphitic material generally refers to a 2-dimensional material that comprises a plurality of layers of graphene (i.e., layers comprising carbon atoms covalently bonded in a hexagonal lattice). Adjacent graphene layers are typically attracted to each other via van der Waals forces, although covalent bonds may also be present between one or more sheets in some cases. In some cases, the carbon-comprising anode active material is or comprises coke (e.g., petroleum coke). In some embodiments, the anode active material comprises silicon, lithium, and/or any alloys of combinations thereof. In some embodiments, the anode active material comprises lithium titanate (Li₄Ti₅O₁₂, also referred to as “LTO”), tin-cobalt oxide, or any combinations thereof.

In some embodiments, the electroactive layer (e.g., including the electroactive material) is deposited on a substrate, such as current collector. For example, in some embodiments, a current collector is adjacent (e.g., directly adjacent) to the electroactive layer such that the current collector can remove current from and/or deliver current to the electroactive layer.

A wide range of current collectors are known in the art. Suitable current collectors may include, for example, metals, metal foils (e.g., aluminum foil), polymer films, metallized polymer films (e.g., aluminized plastic films, such as aluminized polyester film), electrically conductive polymer films, polymer films having an electrically conductive coating, electrically conductive polymer films having an electrically conductive metal coating, and polymer films having conductive particles dispersed therein.

In some embodiments, the current collector includes one or more conductive metals such as aluminum, copper, chromium, stainless steel and/or nickel. For example, a current collector may include a copper metal layer. Optionally, another conductive metal layer, such as titanium, may be positioned on the copper layer. Other current collectors may include, for example, expanded metals, metal mesh, metal grids, expanded metal grids, metal wool, woven carbon fabric, woven carbon mesh, non-woven carbon mesh, and carbon felt. Furthermore, a current collector may be electrochemically inactive. In other embodiments, however, a current collector may comprise an electroactive layer. For example, a current collector may include a material which is used as an electroactive layer (e.g., as an anode or a cathode such as those described herein).

A current collector may have any suitable thickness. For instance, the thickness of a current collector may be greater than or equal to 0.1 microns, greater than or equal to 0.3 microns, greater than or equal to 0.5 microns, greater than or equal to 1 micron, greater than or equal to 3 microns, greater than or equal to 5 microns, greater than or equal to 7 microns, greater than or equal to 9 microns, greater than or equal to 10 microns, greater than or equal to 12 microns, greater than or equal to 15 microns, greater than or equal to 20 microns, greater than or equal to 25 microns, greater than or equal to 30 microns, greater than or equal to 40 microns, or greater than or equal to 50 microns. In some embodiments, the thickness of the current collector may be less than or equal to 50 microns, less than or equal to 40 microns, less than or equal to 30 microns, less than or equal to 25 microns, less than or equal to 20 microns, less than or equal to 15 microns, less than or equal to 12 microns, less than or equal to 10 microns, less than or equal to 9 microns, less than or equal to 7 microns, less than or equal to 5 microns, less than or equal to 3 microns, less than or equal to 1 micron, less than or equal to 0.5 microns, less than or equal to 0.3 microns, or less than or equal to 0.1 microns. Combinations of the above-referenced ranges are also possible (e.g., greater than or equal to 7 microns and less than or equal to 15 microns). Other ranges are possible.

In some embodiments, a separator is disposed adjacent to an electrode (e.g., an electroactive layer).

The separator may be a solid non-electronically conductive or insulative material which separates or insulates a first electrode (e.g., a cathode) and the second electrode (e.g., an anode) from each other preventing short circuiting, and which permits the transport of ions between the first electrode and the second electrode. That is to say, the separator can be electronically insulating but ionically conductive. In some embodiments, the separator can be porous and may be permeable to a liquid electrolyte.

The pores of the separator may be partially or substantially filled with liquid electrolyte. Separators may be supplied as porous free-standing films which are interleaved with the first electrode and the second electrode during the fabrication of cells. Alternatively, the separator layer may be applied directly to the surface of one of the electrodes, for example, as described in PCT Publication No. WO 1999/033125 to Carlson et al. and in U.S. Pat. No. 5,194,341 to Bagley et al.

The separator may include a variety of suitable materials. For example, in some embodiments, the separator comprises a polymer. Examples of suitable separator materials include, but are not limited to, polyolefins, such as, for example, polyethylenes (e.g., SETELA™ made by Tonen Chemical Corp) and polypropylenes, glass fiber filter papers, and ceramic materials. For example, in some embodiments, the separator comprises a microporous polyethylene film. Further examples of separators and separator materials suitable for use in this disclosure are those comprising a microporous xerogel layer, for example, a microporous pseudo-boehmite layer, which may be provided either as a free standing film or by a direct coating application on one of the electrodes, as described in U.S. Pat. Nos. 6,153,337 and 6,306,545. Solid electrolytes and gel electrolytes may also function as a separator in addition to their electrolyte function.

The separator may be any suitable thickness that provides physical separation between a first electrode and a second electrode. In some embodiments, the separator has a thickness of greater than or equal to 1 μm, greater than or equal to 2 μm, greater than or equal to 3 μm, greater than or equal to 4 μm, greater than or equal to 5 μm, greater than or equal to 6 μm, greater than or equal to 9 μm, greater than or equal to 12 μm, greater than or equal 15 μm, greater than or equal to 20 μm, greater than or equal to 25 μm, or more. In some embodiments, the separator has a thickness of less than or equal to 25 μm, less than or equal to 20 μm, less than or equal to 15 μm, less than or equal to 12 μm, less than or equal to 9 μm, less than or equal to 6 μm, less than or equal to 5 μm, less than or equal to 4 μm, less than or equal to 3 μm, less than or equal to 2 μm, less than or equal to 1 μm, or less. Combinations of the above-referenced ranges are also possible (e.g., greater than or equal to 3 μm and less than or equal to 12 μm). Other ranges are possible.

Electrochemical cells described herein may include an electrolyte. The electrolyte can function as a medium for the storage and transport of electroactive species (e.g., ions), and in the special case of solid electrolytes and gel electrolytes, these materials may additionally function as a separator between a first electrode (e.g., a cathode) and a second electrode (e.g., an anode). Any liquid, solid, or gel material capable of storing and transporting ions may be used, so long as the material facilitates the transport of ions (e.g., lithium ions) between an anode and the cathode. The electrolyte may be electronically non-conductive to prevent short circuiting between an anode and a cathode. In some embodiments, the electrolyte may comprise a non-solid electrolyte.

In some embodiments, the electrolyte comprises a liquid that can be added at any point in the fabrication process of an electrochemical cell. In some cases, the electrochemical cell may be fabricated by providing a cathode (which may include a laser-cut electroactive layer as described herein) and an anode (which may also comprise a laser cut electroactive layer as described herein), applying an anisotropic force component normal to the active surface of the second electrode, and subsequently adding the liquid electrolyte such that the electrolyte is in electrochemical communication with the first electrode and the second electrode. In other cases, the liquid electrolyte may be added to the electrochemical cell prior to or simultaneously with the application of an anisotropic force component, after which the electrolyte is in electrochemical communication with the first electrode and the second electrode.

The electrolyte can comprise one or more ionic electrolyte salts to provide ionic conductivity and one or more liquid electrolyte solvents, gel polymer materials, or polymer materials. Suitable non-aqueous electrolytes may include organic electrolytes comprising one or more materials selected from the group consisting of liquid electrolytes, gel polymer electrolytes, and solid polymer electrolytes. Examples of non-aqueous electrolytes for lithium batteries are described by Dorniney in Lithium Batteries, New Materials, Developments and Perspectives, Chapter 4, pp. 137-165, Elsevier, Amsterdam (1994). Examples of gel polymer electrolytes and solid polymer electrolytes are described by Alamgir et al. in Lithium Batteries, New Materials, Developments and Perspectives, Chapter 3, pp. 93-136, Elsevier, Amsterdam (1994). Heterogeneous electrolyte compositions that can be used in batteries described herein are described in U.S. Pat. No. 8,617,748, issued on Dec. 31, 2013 and entitled “Separation of Electrolytes,” which is incorporated herein by reference in its entirety.

In some embodiments, an electrochemical cell includes a liquid electrolyte (e.g., a liquid electrolyte). In some embodiments, the liquid electrolyte comprises a solvent. In some embodiments, the liquid electrolyte. Suitable non-aqueous electrolytes may include organic electrolytes such as liquid electrolytes, gel polymer electrolytes, and solid polymer electrolytes. As mentioned above, these electrolytes may optionally include one or more ionic electrolyte salts (e.g., to provide or enhance ionic conductivity). Examples of useful solvents (e.g., non-aqueous liquid electrolyte solvents) include, but are not limited to, non-aqueous organic solvents, such as, for example, N-methyl acetamide, acetonitrile, acetals, ketals, esters (e.g., esters of carbonic acid, sulfonic acid, an/or phosphoric acid), carbonates (e.g., dimethyl carbonate, diethyl carbonate, ethyl methyl carbonate, propylene carbonate, ethylene carbonate, fluoroethylene carbonate, difluoroethylene carbonate), sulfones, sulfites, sulfolanes, suflonimidies (e.g., bis(trifluoromethane)sulfonimide lithium salt), ethers (e.g., aliphatic ethers, acyclic ethers, cyclic ethers), glymes, polyethers, phosphate esters (e.g., hexafluorophosphate), siloxanes, dioxolanes, N-alkylpyrrolidones (e.g., N-methyl-2-pyrrolidone), nitrate containing compounds, substituted forms of the foregoing, and blends thereof. Examples of acyclic ethers that may be used include, but are not limited to, diethyl ether, dipropyl ether, dibutyl ether, dimethoxymethane, trimethoxymethane, 1,2-dimethoxyethane, diethoxyethane, 1,2-dimethoxypropane, and 1,3-dimethoxypropane. Examples of cyclic ethers that may be used include, but are not limited to, tetrahydrofuran, tetrahydropyran, 2-methyltetrahydrofuran, 1,4-dioxane, 1,3-dioxolane, and trioxane. Examples of polyethers that may be used include, but are not limited to, diethylene glycol dimethyl ether (diglyme), triethylene glycol dimethyl ether (triglyme), tetraethylene glycol dimethyl ether (tetraglyme), higher glymes, ethylene glycol divinyl ether, diethylene glycol divinyl ether, triethylene glycol divinyl ether, dipropylene glycol dimethyl ether, and butylene glycol ethers. Examples of sulfones that may be used include, but are not limited to, sulfolane, 3-methyl sulfolane, and 3-sulfolene. Fluorinated derivatives of the foregoing are also useful as liquid electrolyte solvents.

In some cases, mixtures of the solvents described herein may also be used. For example, in some embodiments, mixtures of solvents are selected from the group consisting of 1,3-dioxolane and dimethoxyethane, 1,3-dioxolane and diethyleneglycol dimethyl ether, 1,3-dioxolane and triethyleneglycol dimethyl ether, and 1,3-dioxolane and sulfolane. In some embodiments, the mixture of solvents comprises dimethyl carbonate and ethylene carbonate. In some embodiments, the mixture of solvents comprises ethylene carbonate and ethyl methyl carbonate. The weight ratio of the two solvents in the mixtures may range, in some cases, from about 5 wt %:95 wt % to 95 wt %:5 wt %. For example, in some embodiments the electrolyte comprises a 50 wt %:50 wt % mixture of dimethyl carbonate:ethylene carbonate. In some other embodiments, the electrolyte comprises a 30 wt %:70 wt % mixture of ethylene carbonate:ethyl methyl carbonate. An electrolyte may comprise a mixture of dimethyl carbonate:ethylene carbonate with a ratio of dimethyl carbonate:ethylene carbonate that is less than or equal to 50 wt %:50 wt % and greater than or equal to 30 wt %:70 wt %.

In some embodiments, an electrolyte may comprise a mixture of fluoroethylene carbonate and dimethyl carbonate. A weight ratio of fluoroethylene carbonate to dimethyl carbonate may be 20 wt %:80 wt % or 25 wt %:75 wt %. A weight ratio of fluoroethylene carbonate to dimethyl carbonate may be greater than or equal to 20 wt %:80 wt % and less than or equal to 25 wt %:75 wt %.

In some cases, aqueous solvents can be used as electrolytes, for example, in lithium cells. Aqueous solvents can include water, which can comprise other components such as ionic salts. As noted above, in some embodiments, the electrolyte can include species such as lithium hydroxide, or other species rendering the electrolyte basic, so as to reduce the concentration of hydrogen ions in the electrolyte.

Liquid electrolyte solvents can also be useful as plasticizers for gel polymer electrolytes, i.e., electrolytes comprising one or more polymers forming a semi-solid network. Examples of useful gel polymer electrolytes include, but are not limited to, those comprising one or more polymers selected from the group consisting of polyethylene oxides, polypropylene oxides, polyacrylonitriles, polysiloxanes, polyimides, polyphosphazenes, polyethers, sulfonated polyimides, perfluorinated membranes (NAFION resins), polydivinyl polyethylene glycols, polyethylene glycol diacrylates, polyethylene glycol dimethacrylates, polysulfones, polyethersulfones, derivatives of the foregoing, copolymers of the foregoing, crosslinked and network structures of the foregoing, and blends of the foregoing, and optionally, one or more plasticizers. In some embodiments, a gel polymer electrolyte comprises between 10-20%, between 20-40%, between 60-70%, between 70-80%, between 80-90%, or between 90-95% of a heterogeneous electrolyte by volume.

In some embodiments, one or more solid polymers can be used to form an electrolyte. Examples of useful solid polymer electrolytes include, but are not limited to, those comprising one or more polymers selected from the group consisting of polyethers, polyethylene oxides, polypropylene oxides, polyimides, polyphosphazenes, polyacrylonitriles, polysiloxanes, derivatives of the foregoing, copolymers of the foregoing, crosslinked and network structures of the foregoing, and blends of the foregoing.

In addition to electrolyte solvents, gelling agents, and polymers as known in the art for forming electrolytes, the electrolyte may further comprise one or more ionic electrolyte salts, also as known in the art, to increase the ionic conductivity.

In some embodiments, an electrolyte is in the form of a layer having a particular thickness. An electrolyte layer may have a thickness of, for example, at least 1 micron, at least 5 microns, at least 10 microns, at least 15 microns, at least 20 microns, at least 25 microns, at least 30 microns, at least 40 microns, at least 50 microns, at least 70 microns, at least 100 microns, at least 200 microns, at least 500 microns, or at least 1 mm. In some embodiments, the thickness of the electrolyte layer is less than or equal to 1 mm, less than or equal to 500 microns, less than or equal to 200 microns, less than or equal to 100 microns, less than or equal to 70 microns, less than or equal to 50 microns, less than or equal to 40 microns, less than or equal to 30 microns, less than or equal to 20 microns, less than or equal to 10 microns, or less than or equal to 5 microns. Other values are also possible. Combinations of the above-noted ranges are also possible.

An electroactive species may be present as an ionic electrolyte salt. Examples of ionic electrolyte salts for use in the electrolyte of the electrochemical cells described herein include, but are not limited to, LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂, and lithium bis(fluorosulfonyl)imide (LiFSI). Other electrolyte salts that may be useful include lithium polysulfides (Li₂Sₓ), and lithium salts of organic polysulfides (LiSₓR)ₙ, where x is an integer from 1 to 20, n is an integer from 1 to 3, and R is an organic group, and those disclosed in U.S. Pat. No. 5,538,812 to Lee et al., which is incorporated herein by reference in its entirety for all purposes.

In some embodiments, the electrolyte comprises one or more room temperature ionic liquids. The room temperature ionic liquid, if present, typically comprises one or more cations and one or more anions. Non-limiting examples of suitable cations include lithium cations and/or one or more quaternary ammonium cations such as imidazolium, pyrrolidinium, pyridinium, tetraalkylammonium, pyrazolium, piperidinium, pyridazinium, pyrimidinium, pyrazinium, oxazolium, and trizolium cations. Non-limiting examples of suitable anions include trifluromethylsulfonate (CF₃SO₃⁻), bis (fluorosulfonyl)imide (N(FSO₂)₂, bis (trifluoromethyl sulfonyl)imide ((CF₃SO₂)₂N⁻, bis (perfluoroethylsulfonyl)imide((CF₃CF₂SO₂)₂N⁻ and tris(trifluoromethylsulfonyl)methide ((CF₃SO₂)₃C⁻. Non-limiting examples of suitable ionic liquids include N-methyl-N-propylpyrrolidinium/bis(fluorosulfonyl) imide and 1,2-dimethyl-3-propylimidazolium/bis(trifluoromethanesulfonyl)imide. In some embodiments, the electrolyte comprises both a room temperature ionic liquid and a lithium salt. In some other embodiments, the electrolyte comprises a room temperature ionic liquid and does not include a lithium salt.

When present, a lithium salt may be present in the electrolyte at a variety of suitable concentrations. In some embodiments, the lithium salt is present in the electrolyte at a concentration of greater than or equal to 0.01 M, greater than or equal to 0.02 M, greater than or equal to 0.05 M, greater than or equal to 0.1 M, greater than or equal to 0.2 M, greater than or equal to 0.5 M, greater than or equal to 1 M, greater than or equal to 2 M, or greater than or equal to 5 M. The lithium salt may be present in the electrolyte at a concentration of less than or equal to 10 M, less than or equal to 5 M, less than or equal to 2 M, less than or equal to 1 M, less than or equal to 0.5 M, less than or equal to 0.2 M, less than or equal to 0.1 M, less than or equal to 0.05 M, or less than or equal to 0.02 M. Combinations of the above-referenced ranges are also possible (e.g., greater than or equal to 0.01 M and less than or equal to 10 M, or greater than or equal to 0.01 M and less than or equal to 5 M). Other ranges are also possible.

In some embodiments, an electrolyte may comprise LiPF₆ in an advantageous amount. In some embodiments, the electrolyte comprises LiPF₆ at a concentration of greater than or equal to 0.01 M, greater than or equal to 0.02 M, greater than or equal to 0.05 M, greater than or equal to 0.1 M, greater than or equal to 0.2 M, greater than or equal to 0.5 M, greater than or equal to 1 M, or greater than or equal to 2 M. The electrolyte may comprise LiPF₆ at a concentration of less than or equal to 5 M, less than or equal to 2 M, less than or equal to 1 M, less than or equal to 0.5 M, less than or equal to 0.2 M, less than or equal to 0.1 M, less than or equal to 0.05 M, or less than or equal to 0.02 M. Combinations of the above-referenced ranges are also possible (e.g., greater than or equal to 0.01 M and less than or equal to 5 M). Other ranges are also possible.

In some embodiments, an electrolyte comprises a species with an oxalato(borate) group (e.g., LiBOB, lithium difluoro(oxalato)borate), and the total weight of the species with an (oxalato)borate group in the electrolyte may be less than or equal to 30 wt %, less than or equal to 28 wt %, less than or equal to 25 wt %, less than or equal to 22 wt %, less than or equal to 20 wt %, less than or equal to 18 wt %, less than or equal to 15 wt %, less than or equal to 12 wt %, less than or equal to 10 wt %, less than or equal to 8 wt %, less than or equal to 6 wt %, less than or equal to 5 wt %, less than or equal to 4 wt %, less than or equal to 3 wt %, less than or equal to 2 wt %, or less than or equal to 1 wt % versus the total weight of the electrolyte. In some embodiments, the total weight of the species with an (oxalato)borate group in the electrochemical cell is greater than 0.2 wt %, greater than 0.5 wt %, greater than 1 wt %, greater than 2 wt %, greater than 3 wt %, greater than 4 wt %, greater than 6 wt %, greater than 8 wt %, greater than 10 wt %, greater than 15 wt %, greater 18 wt %, greater than 20 wt %, greater than 22 wt %, greater than 25 wt %, or greater than 28 wt % versus the total weight of the electrolyte. Combinations of the above-referenced ranges are also possible (e.g., greater than 0.2 wt % and less than or equal to 30 wt %, greater than 0.2 wt % and less than or equal to 20 wt %, greater than 0.5 wt % and less than or equal to 20 wt %, greater than 1 wt % and less than or equal to 8 wt %, greater than 1 wt % and less than or equal to 6 wt %, greater than 4 wt % and less than or equal to 10 wt %, greater than 6 wt % and less than or equal to 15 wt %, or greater than 8 wt % and less than or equal to 20 wt %). Other ranges are also possible.

In some embodiments, an electrolyte comprises fluoroethylene carbonate. In some embodiments, the total weight of the fluoroethylene carbonate in the electrolyte may be less than or equal to 30 wt %, less than or equal to 28 wt %, less than or equal to 25 wt %, less than or equal to 22 wt %, less than or equal to 20 wt %, less than or equal to 18 wt %, less than or equal to 15 wt %, less than or equal to 12 wt %, less than or equal to 10 wt %, less than or equal to 8 wt %, less than or equal to 6 wt %, less than or equal to 5 wt %, less than or equal to 4 wt %, less than or equal to 3 wt %, less than or equal to 2 wt %, or less than or equal to 1 wt % versus the total weight of the electrolyte. In some embodiments, the total weight of the fluoroethylene carbonate in the electrolyte is greater than 0.2 wt %, greater than 0.5 wt %, greater than 1 wt %, greater than 2 wt %, greater than 3 wt %, greater than 4 wt %, greater than 6 wt %, greater than 8 wt %, greater than 10 wt %, greater than 15 wt %, greater than 18 wt %, greater than 20 wt %, greater than 22 wt %, greater than 25 wt %, or greater than 28 wt % versus the total weight of the electrolyte. Combinations of the above-referenced ranges are also possible (e.g., less than or equal to 0.2 wt % and greater than 30 wt %, less than or equal to 15 wt % and greater than 20 wt %, or less than or equal to 20 wt % and greater than 25 wt %). Other ranges are also possible.

In some embodiments, an electrolyte may comprise several species together that are particularly beneficial in combination. For instance, in some embodiments, the electrolyte comprises fluoroethylene carbonate, dimethyl carbonate, and LiPF₆. The weight ratio of fluoroethylene carbonate to dimethyl carbonate may be between 20 wt %:80 wt % and 25 wt %:75 wt % and the concentration of LiPF₆ in the electrolyte may be approximately 1 M (e.g., between 0.05 M and 2 M). The electrolyte may further comprise lithium bis(oxalato)borate (e.g., at a concentration between 0.1 wt % and 6 wt %, between 0.5 wt % and 6 wt %, or between 1 wt % and 6 wt % in the electrolyte), and/or lithium tris(oxalato)phosphate (e.g., at a concentration between 1 wt % and 6 wt % in the electrolyte).

Electrochemical cells and/or electrodes comprising laser-cut electroactive layers as described herein may be under an applied anisotropic force. As understood in the art, an “anisotropic force” is a force that is not equal in all directions. In some embodiments, the electrochemical cells and/or the electrodes can be configured to withstand an applied anisotropic force (e.g., a force applied to enhance the morphology of an electrode within the cell) while maintaining their structural integrity. The electrodes described herein may be a part of an electrochemical cell that is adapted and arranged such that, during at least one period of time during charge and/or discharge of the cell, an anisotropic force with a component normal to the active surface of an electrode (e.g., a porous electroactive region of an electrode) within the electrochemical cell is applied to the cell.

In some such cases, the anisotropic force comprises a component normal to an active surface of an electrode (e.g., a first electrode, a second electrode) within an electrochemical cell. As used herein, the term “active surface” is used to describe a surface of an electrode at which electrochemical reactions may take place. A force with a “component normal” to a surface is given its ordinary meaning as would be understood by those of ordinary skill in the art and includes, for example, a force which at least in part exerts itself in a direction substantially perpendicular to the surface. For example, in the case of a horizontal table with an object resting on the table and affected only by gravity, the object exerts a force essentially completely normal to the surface of the table. If the object is also urged laterally across the horizontal table surface, then it exerts a force on the table which, while not completely perpendicular to the horizontal surface, includes a component normal to the table surface. Those of ordinary skill will understand other examples of these terms, especially as applied within the description of this disclosure. In the case of a curved surface (for example, a concave surface or a convex surface), the component of the anisotropic force that is normal to an active surface of an electrode may correspond to the component normal to a plane that is tangent to the curved surface at the point at which the anisotropic force is applied. The anisotropic force may be applied, in some cases, at one or more pre-determined locations, in some cases distributed over the active surface of an electrode. In some embodiments, the anisotropic force is applied uniformly over the active surface of the first electrode (e.g., a porous electrode) and/or the second electrode (e.g., an anode).

Any of the electrochemical cell properties and/or performance metrics described herein may be achieved, alone or in combination with each other, while an anisotropic force is applied to the electrochemical cell (e.g., during charge and/or discharge of the cell). In some embodiments, the anisotropic force applied to the electrode or to the electrochemical cell (e.g., during at least one period of time during charge and/or discharge of the cell) can include a component normal to an active surface of an electrode (e.g., an active surface of a lithium metal containing electrode and/or an active surface of a porous electroactive region of an electrode).

In some embodiments, the component of the anisotropic force that is normal to the active surface of the electrode defines a pressure of greater than or equal to 1 kgf/cm², greater than or equal to 2 kgf/cm², greater than or equal to 4 kgf/cm², greater than or equal to 6 kgf/cm², greater than or equal to 7.5 kgf/cm², greater than or equal to 8 kgf/cm², greater than or equal to 10 kgf/cm², greater than or equal to 12 kgf/cm², greater than or equal to 14 kgf/cm², greater than or equal to 16 kgf/cm², greater than or equal to 18 kgf/cm², greater than or equal to 20 kgf/cm², greater than or equal to 22 kgf/cm², greater than or equal to 24 kgf/cm², greater than or equal to 26 kgf/cm², greater than or equal to 28 kgf/cm², greater than or equal to 30 kgf/cm², greater than or equal to 32 kgf/cm², greater than or equal to 34 kgf/cm², greater than or equal to 36 kgf/cm², greater than or equal to 38 kgf/cm², greater than or equal to 40 kgf/cm², greater than or equal to 42 kgf/cm², greater than or equal to 44 kgf/cm², greater than or equal to 46 kgf/cm², greater than or equal to 48 kgf/cm², or more. In some embodiments, the component of the anisotropic force normal to the active surface may, for example, define a pressure of less than or equal to 50 kgf/cm², less than or equal to 48 kgf/cm², less than or equal to 46 kgf/cm², less than or equal to 44 kgf/cm², less than or equal to 42 kgf/cm², less than or equal to 40 kgf/cm², less than or equal to 38 kgf/cm², less than or equal to 36 kgf/cm², less than or equal to 34 kgf/cm², less than or equal to 32 kgf/cm², less than or equal to 30 kgf/cm², less than or equal to 28 kgf/cm², less than or equal to 26 kgf/cm², less than or equal to 24 kgf/cm², less than or equal to 22 kgf/cm², less than or equal to 20 kgf/cm², less than or equal to 18 kgf/cm², less than or equal to 16 kgf/cm², less than or equal to 14 kgf/cm², less than or equal to 12 kgf/cm², less than or equal to 10 kgf/cm², less than or equal to 8 kgf/cm², less than or equal to 6 kgf/cm², less than or equal to 4 kgf/cm², less than or equal to 2 kgf/cm², or less. Combinations of the above-referenced ranges are also possible (e.g., greater than or equal tol kgf/cm² and less than or equal to 50 kgf/cm²). Other ranges are possible.

The anisotropic forces applied during at least a portion of charge and/or discharge may be applied using any method known in the art. In some embodiments, the force may be applied using compression springs. Forces may be applied using other elements (either inside or outside a containment structure) including, but not limited to Belleville washers, machine screws, pneumatic devices, and/or weights, among others. In some cases, cells may be pre-compressed before they are inserted into containment structures, and, upon being inserted to the containment structure, they may expand to produce a net force on the cell. Suitable methods for applying such forces are described in detail, for example, in U.S. Pat. No. 9,105,938, which is incorporated herein by reference in its entirety.

As described above, a laser may be used to cut the electroactive layer and/or the current collector. Non-limiting details regarding the laser are described below.

The laser may be any type of laser suitable for cutting the electroactive layer and/or the current collector. For example, in some embodiments, the laser is a YAG (yttrium aluminum garnet) laser, which can be optionally doped with neodymium, i.e., a neodymium-doped yttrium aluminum garnet (Nd:Y3A15012) laser. In some embodiments, the laser gas laser, such as a carbon dioxide (CO₂) laser. In some embodiments, the laser is a fiber laser (e.g., a green fiber laser, 500 nm). Other lasers are possible as this disclosure is not so limited.

In some embodiments, the laser is configured to apply laser pulses. Each laser pulse may have a particular duration of time (e.g., femtoseconds, picoseconds). In some embodiments, a laser pulse has a duration of greater than or equal to 50 fs, greater than or equal to 100 fs, greater than or equal to 200 fs, greater than or equal to 300 fs, greater than or equal to 500 fs, greater than or equal to 750 fs, greater than or equal to 1 ps, greater than or equal to 25 ps, greater than or equal to 50 ps, greater than or equal to 100 ps, greater than or equal to 250 ps, greater than or equal to 500 ps, greater than or equal to 750 ps, or greater than or equal to 1000 ps. In some embodiments, the laser pulse has a duration of less than or equal to 1000 ps, less than or equal to 750 ps, less than or equal to 500 ps, less than or equal to 250 ps, less than or equal to 100 ps, less than or equal to 50 ps, less than or equal to 25 ps, less than or equal to 1 ps, less than or equal to 750 fs, less than or equal to 500 fs, less than or equal to 300 fs, less than or equal to 200 fs, less than or equal to 100 fs, or less than or equal to 50 fs. Combinations of the above-referenced ranges are also possible (e.g., greater than or equal to 50 fs and less than or equal to 1000 ps). Other ranges are possible.

The laser may have a particular average laser power. In some embodiments, the average laser power is greater than or equal to 0.5 W, greater than or equal to 0.6 W, greater than or equal to 0.7 W, greater than or equal to 0.8 W, greater than or equal to 0.9 W, greater than or equal to 1 W, greater than or equal to 2 W, greater than or equal to 5 W, greater than or equal to 7 W, greater than or equal to 9 W, greater than or equal to 10 W, greater than or equal to 12 W, greater than or equal to 15 W, greater than or equal to 20 W, greater than or equal to 25 W, greater than or equal to 50 W, greater than or equal to 75 W, greater than or equal to 100 W, greater than or equal to 150 W, greater than or equal to 200 W, greater than or equal to 250 W, greater than or equal to 300 W, greater than or equal to 350 W, greater than or equal to 400 W, greater than or equal to 450 W, or greater than or equal to 500 W. In some embodiments, an average laser power is less than or equal to 500 W, less than or equal to 450 W, less than or equal to 400 W, less than or equal to 350 W, less than or equal to 300 W, less than or equal to 250 W, less than or equal to 200 W, less than or equal to 150 W, less than or equal to 100 W, less than or equal to 75 W, less than or equal to 50 W, less than or equal to 25 W, less than or equal to 20 W, less than or equal to 15 W, less than or equal to 12 W, less than or equal to 10 W, less than or equal to 9 W, less than or equal to 7 W, less than or equal to 5 W, less than or equal to 2 W, less than or equal to 1 W, less than or equal to 0.9 W, less than or equal to 0.7 W, less than or equal to 0.6 W, or less than or equal to 0.5 W. Combinations of the above-referenced ranges are also possible (e.g., greater than or equal to 100 W and less than or equal to 200 W). Other ranges are possible.

In some embodiments, the laser may have a particular peak power during the duration of time in which the laser pulse is provided. In some embodiments, the peak power is greater than or equal to 10⁸ W/cm², greater than or equal to 10⁹ W/cm², greater than or equal to 10¹⁰ W/cm², greater than or equal to 10¹¹ W/cm², greater than or equal to 10¹² W/cm², greater than or equal to 10¹³ W/cm², greater than or equal to 10¹⁴ W/cm², or greater than or equal to 10¹⁵ W/cm². In some embodiments, the peak power is less than or equal to 10¹⁵ W/cm², less than or equal to 10¹⁴ W/cm², less than or equal to 10¹³ W/cm², less than or equal to 10¹² W/cm², less than or equal to 10¹¹ W/cm², less than or equal to 10¹⁰ W/cm², less than or equal to 10⁹ W/cm², or less than or equal to 10⁸ W/cm². Combinations of the above-referenced ranges are also possible (e.g., greater than or equal to 10⁸ and less than or equal to 10¹⁵ W/cm²). Other ranges are possible.

In some embodiments, the laser (e.g., laser spot) provides a particular fluence. In some embodiments fluence of the laser is greater than or equal to 5 J/cm², greater than or equal to 7 J/cm², greater than or equal to 10 J/cm², greater than or equal to 15 J/cm², greater than or equal to 20 J/cm², greater than or equal to 25 J/cm², greater than or equal to 50 J/cm², greater than or equal to 100 J/cm², greater than or equal to 150 J/cm², greater than or equal to 200 J/cm², greater than or equal to 250 J/cm², greater than or equal to 300 J/cm², greater than or equal to 350 J/cm², greater than or equal to 400 J/cm², greater than or equal to 500 J/cm², greater than or equal to 550 J/cm², greater than or equal to 600 J/cm², greater than or equal to 650 J/cm², greater than or equal to 700 J/cm², greater than or equal to 750 J/cm², or greater than or equal to 800 J/cm². In some embodiments, the fluence of the laser is less than or equal to 800 J/cm², less than or equal to 750 J/cm², less than or equal to 700 J/cm², less than or equal to 650 J/cm², less than or equal to 600 J/cm², less than or equal to 550 J/cm², less than or equal to 500 J/cm², less than or equal to 450 J/cm², less than or equal to 400 J/cm², less than or equal to 350 J/cm², less than or equal to 300 J/cm², less than or equal to 250 J/cm², less than or equal to 200 J/cm², less than or equal to 150 J/cm², less than or equal to 100 J/cm², less than or equal to 50 J/cm², less than or equal to 25 J/cm², less than or equal to 20 J/cm², less than or equal to 15 J/cm², less than or equal to 10 J/cm², less than or equal to 7 J/cm², or less than or equal to 5 J/cm². Combinations of the above-referenced ranges are also possible (e.g., greater than or equal to 5 J/cm² and less than or equal to 800 J/cm²). Other ranges are possible.

The laser may be configured to cut (e.g., the electroactive layer, the current collector) with a particular cutting speed. In some embodiments, the cutting speed of the laser is greater than or equal to 0.5 mm/s, greater than or equal to 1 mm/s, greater than or equal to 1.8 mm/s, greater than or equal to 2 mm/s, greater than or equal to 3 mm/s, greater than or equal to 4 mm/s, greater than or equal to 5 mm/s, greater than or equal to 6 mm/s, greater than or equal to 7 mm/s, greater than or equal to 8 mm/s, greater than or equal to 9 mm/s, greater than or equal to 10 mm/s, greater than or equal to 12 mm/s, greater than or equal to 15 mm/s, greater than or equal to 18 mm/s, greater than or equal to 20 mm/s, greater than or equal to 22 mm/s, greater than or equal to 25 mm/s, greater than or equal to 50 mm/s, greater than or equal to 75 mm/s, greater than or equal to 100 mm/s, greater than or equal to 150 mm/s, greater than or equal to 200 mm/s, greater than or equal to 250 mm/s, greater than or equal to 300 mm/s, greater than or equal to 350 mm/s, greater than or equal to 400 mm/s, greater than or equal to 450 mm/s, or greater than or equal to 500 mm/s. In some embodiments, the cutting speed of the laser is less than or equal to 500 mm/s, less than or equal to 450 mm/s, less than or equal to 400 mm/s, less than or equal to 350 mm/s, less than or equal to 300 mm/s, less than or equal to 250 mm/s, less than or equal to 200 mm/s, less than or equal to 150 mm/s, less than or equal to 100 mm/s, less than or equal to 75 mm/s, less than or equal to 50 mm/s, less than or equal to 25 mm/s, less than or equal to 22 mm/s, less than or equal to 20 mm/s, less than or equal to 18 mm/s, less than or equal to 15 mm/s, less than or equal to 12 mm/s, less than or equal to 10 mm/s, less than or equal to 9 mm/s, less than or equal to 8 mm/s, less than or equal to 7 mm/s, less than or equal to 6 mm/s, less than or equal to 5 mm/s, less or equal to 4 mm/s, less than or equal to 3 mm/s, less than or equal to 2 mm/s, less than or equal to 1.8 mm/s, less than or equal to 1 mm/s, or less than or equal 0.5 mm/s. Combinations of the above-referenced ranges are also possible (e.g., greater than or equal to 0.5 mm/s and less than or equal to 25 mm/s). Other ranges are possible.

In some embodiments, the laser can cut all or a portion of electroactive layer, a current collector, and/or a separator (e.g., a thickness of one or more of these components). In some embodiments, laser can cut a thickness of greater than or equal to 10 microns, greater than or equal to 20 microns, greater than or equal to 30 microns, greater than or equal to 40 microns, greater than or equal to 50 microns, greater than or equal to 75 microns, greater than or equal to 100 microns, greater than or equal to 150 microns, greater than or equal to 200 microns, greater than or equal to 300 microns, greater than or equal to 400 microns, greater than or equal to 500 microns, or more. In some embodiments, the laser can cut a thickness of less than or equal to 500 microns, less than or equal to 400 microns, less than or equal to 300 microns, less than or equal to 200 microns, less than or equal to 150 microns, less than or equal to 100 microns, less than or equal to 75 microns, less than or equal to 50 microns, less than or equal to 40 microns less than or equal to 30 microns, less than or equal to 20 microns, less than or equal to 10 microns, or less. Combinations of the above-referenced ranges are also possible (e.g., greater than or equal to 50 microns and less than or equal to 150 microns). Other ranges are possible.

### INCORPORATED BY REFERENCE

The following applications are incorporated herein by reference, in their entirety, for all purposes: U.S. Publication No. US-2007-0221265-A1 published on Sep. 27, 2007, filed as U.S. application Ser. No. 11/400,781 on Apr. 6, 2006, and entitled “RECHARGEABLE LITHIUM/WATER, LITHIUM/AIR BATTERIES”; U.S. Publication No. US-2009-0035646-A1, published on Feb. 5, 2009, filed as U.S. application Ser. No. 11/888,339 on Jul. 31, 2007, and entitled “SWELLING INHIBITION IN BATTERIES”; U.S. Publication No. US-2010-0129699-A1 published on May 17, 2010, filed as U.S. application Ser. No. 12/312,764 on Feb. 2, 2010; patented as U.S. Pat. No. 8,617,748 on Dec. 31, 2013, and entitled “SEPARATION OF ELECTROLYTES”; U.S. Publication No. US-2010-0291442-A1 published on Nov. 18, 2010, filed as U.S. application Ser. No. 12/682,011 on Jul. 30, 2010, patented as U.S. Pat. No. 8,871,387 on Oct. 28, 2014, and entitled “PRIMER FOR BATTERY ELECTRODE”; U.S. Publication No. US-2009-0200986-A1 published on Aug. 13, 2009, filed as U.S. application Ser. No. 12/069,335 on Feb. 8, 2008, patented as U.S. Pat. No. 8,264,205 on Sep. 11, 2012, and entitled “CIRCUIT FOR CHARGE AND/OR DISCHARGE PROTECTION IN AN ENERGY-STORAGE DEVICE”; U.S. Publication No. US-2007-0224502-A1 published on Sep. 27, 2007, filed as U.S. application Ser. No. 11/400,025 on Apr. 6, 2006, patented as U.S. Pat. No. 7,771,870 on Aug. 10, 2010, and entitled “ELECTRODE PROTECTION IN BOTH AQUEOUS AND NON-AQUEOUS ELECTROCHEMICAL CELLS, INCLUDING RECHARGEABLE LITHIUM BATTERIES”; U.S. Publication No. US-2008-0318128-A1 published on Dec. 25, 2008, filed as U.S. application Ser. No. 11/821,576 on Jun. 22, 2007, and entitled “LITHIUM ALLOY/SULFUR BATTERIES”; U.S. Publication No. US-2002-0055040-A1 published on May 9, 2002, filed as U.S. application Ser. No. 09/795,915 on Feb. 27, 2001, patented as U.S. Pat. No. 7,939,198 on May 10, 2011, and entitled “NOVEL COMPOSITE CATHODES, ELECTROCHEMICAL CELLS COMPRISING NOVEL COMPOSITE CATHODES, AND PROCESSES FOR FABRICATING SAME”; U.S. Publication No. US-2006-0238203-A1 published on Oct. 26, 2006, filed as U.S. application Ser. No. 11/111,262 on Apr. 20, 2005, patented as U.S. Pat. No. 7,688,075 on Mar. 30, 2010, and entitled “LITHIUM SULFUR RECHARGEABLE BATTERY FUEL GAUGE SYSTEMS AND METHODS”; U.S. Publication No. US-2008-0187663-A1 published on Aug. 7, 2008, filed as U.S. application Ser. No. 11/728,197 on Mar. 23, 2007, patented as U.S. Pat. No. 8,084,102 on Dec. 27, 2011, and entitled “METHODS FOR CO-FLASH EVAPORATION OF POLYMERIZABLE MONOMERS AND NON-POLYMERIZABLE CARRIER SOLVENT/SALT MIXTURES/SOLUTIONS”; U.S. Publication No. US-2011-0006738-A1 published on Jan. 13, 2011, filed as U.S. application Ser. No. 12/679,371 on Sep. 23, 2010, and entitled “ELECTROLYTE ADDITIVES FOR LITHIUM BATTERIES AND RELATED METHODS”; U.S. Publication No. US-2011-0008531-A1 published on Jan. 13, 2011, filed as U.S. application Ser. No. 12/811,576 on Sep. 23, 2010, patented as U.S. Pat. No. 9,034,421 on May 19, 2015, and entitled “METHODS OF FORMING ELECTRODES COMPRISING SULFUR AND POROUS MATERIAL COMPRISING CARBON”; U.S. Publication No. US-2010-0035128-A1 published on Feb. 11, 2010, filed as U.S. application Ser. No. 12/535,328 on Aug. 4, 2009, patented as U.S. Pat. No. 9,105,938 on Aug. 11, 2015, and entitled “APPLICATION OF FORCE IN ELECTROCHEMICAL CELLS”; U.S. Publication No. US-2011-0165471-A9 published on Jul. 15, 2011, filed as U.S. application Ser. No. 12/180,379 on Jul. 25, 2008, and entitled “PROTECTION OF ANODES FOR ELECTROCHEMICAL CELLS”; U.S. Publication No. US-2006-0222954-A1 published on Oct. 5, 2006, filed as U.S. application Ser. No. 11/452,445 on Jun. 13, 2006, patented as U.S. Pat. No. 8,415,054 on Apr. 9, 2013, and entitled “LITHIUM ANODES FOR ELECTROCHEMICAL CELLS”; U.S. Publication No. US-2010-0239914-A1 published on Sep. 23, 2010, filed as U.S. application Ser. No. 12/727,862 on Mar. 19, 2010, and entitled “CATHODE FOR LITHIUM BATTERY”; U.S. Publication No. US-2010-0294049-A1 published on Nov. 25, 2010, filed as U.S. application Ser. No. 12/471,095 on May 22, 2009, patented as U.S. Pat. No. 8,087,309 on Jan. 3, 2012, and entitled “HERMETIC SAMPLE HOLDER AND METHOD FOR PERFORMING MICROANALYSIS UNDER CONTROLLED ATMOSPHERE ENVIRONMENT”; U.S. Publication No. US-2011-0076560-A1 published on Mar. 31, 2011, filed as U.S. application Ser. No. 12/862,581 on Aug. 24, 2010, and entitled “ELECTROCHEMICAL CELLS COMPRISING POROUS STRUCTURES COMPRISING SULFUR”; U.S. Publication No. US-2011-0068001-A1 published on Mar. 24, 2011, filed as U.S. application Ser. No. 12/862,513 on Aug. 24, 2010, and entitled “RELEASE SYSTEM FOR ELECTROCHEMICAL CELLS”; U.S. Publication No. US-2012-0048729-A1 published on Mar. 1, 2012, filed as U.S. application Ser. No. 13/216,559 on Aug. 24, 2011, and entitled “ELECTRICALLY NON-CONDUCTIVE MATERIALS FOR ELECTROCHEMICAL CELLS”; U.S. Publication No. US-2011-0177398-A1 published on Jul. 21, 2011, filed as U.S. application Ser. No. 12/862,528 on Aug. 24, 2010, patented as U.S. Pat. No. 10,629,947 on Apr. 21, 2020, and entitled “ELECTROCHEMICAL CELL”; U.S. Publication No. US-2011-0070494-A1 published on Mar. 24, 2011, filed as U.S. application Ser. No. 12/862,563 on Aug. 24, 2010, and entitled “ELECTROCHEMICAL CELLS COMPRISING POROUS STRUCTURES COMPRISING SULFUR”; U.S. Publication No. US-2011-0070491-A1 published on Mar. 24, 2011, filed as U.S. application Ser. No. 12/862,551 on Aug. 24, 2010, and entitled “ELECTROCHEMICAL CELLS COMPRISING POROUS STRUCTURES COMPRISING SULFUR”; U.S. Publication No. US-2011-0059361-A1 published on Mar. 10, 2011, filed as U.S. application Ser. No. 12/862,576 on Aug. 24, 2010, patented as U.S. Pat. No. 9,005,809 on Apr. 14, 2015, and entitled “ELECTROCHEMICAL CELLS COMPRISING POROUS STRUCTURES COMPRISING SULFUR”; U.S. Publication No. US-2012-0052339-A1 published on Mar. 1, 2012, filed as U.S. application Ser. No. 13/216,579 on Aug. 24, 2011, and entitled “ELECTROLYTE MATERIALS FOR USE IN ELECTROCHEMICAL CELLS”; U.S. Publication No. US-2012-0070746-A1 published on Mar. 22, 2012, filed as U.S. application Ser. No. 13/240,113 on Sep. 22, 2011, and entitled “LOW ELECTROLYTE ELECTROCHEMICAL CELLS”; U.S. Publication No. US-2011-0206992-A1 published on Aug. 25, 2011, filed as U.S. application Ser. No. 13/033,419 on Feb. 23, 2011, and entitled “POROUS STRUCTURES FOR ENERGY STORAGE DEVICES”; U.S. Publication No. US-2012-0082872-A1 published on Apr. 5, 2012, filed as U.S. application Ser. No. 13/249,605 on Sep. 30, 2011, and entitled “ADDITIVE FOR ELECTROLYTES”; U.S. Publication No. US-2012-0082901-A1 published on Apr. 5, 2012, filed as U.S. application Ser. No. 13/249,632 on Sep. 30, 2011, and entitled “LITHIUM-BASED ANODE WITH IONIC LIQUID POLYMER GEL”; U.S. Publication No. US-2013-0164635-A1 published on Jun. 27, 2013, filed as U.S. application Ser. No. 13/700,696 on Mar. 6, 2013, patented as U.S. Pat. No. 9,577,243 on Feb. 21 2017, and entitled “USE OF EXPANDED GRAPHITE IN LITHIUM/SULPHUR BATTERIES”; U.S. Publication No. US-2013-0017441-A1 published on Jan. 17, 2013, filed as U.S. application Ser. No. 13/524,662 on Jun. 15, 2012, patented as U.S. Pat. No. 9,548,492 on Jan. 17, 2017, and entitled “PLATING TECHNIQUE FOR ELECTRODE”; U.S. Publication No. US-2013-0224601-A1 published on Aug. 29, 2013, filed as U.S. application Ser. No. 13/766,862 on Feb. 14, 2013, patented as U.S. Pat. No. 9,077,041 on Jul. 7, 2015, and entitled “ELECTRODE STRUCTURE FOR ELECTROCHEMICAL CELL”; U.S. Publication No. US-2013-0252103-A1 published on Sep. 26, 2013, filed as U.S. application Ser. No. 13/789,783 on Mar. 8, 2013, patented as U.S. Pat. No. 9,214,678 on Dec. 15, 2015, and entitled “POROUS SUPPORT STRUCTURES, ELECTRODES CONTAINING SAME, AND ASSOCIATED METHODS”; U.S. Publication No. US-2015-0287998-A1 published on Oct. 8, 2015, filed as U.S. application Ser. No. 14/743,304 on Jun. 18, 2015, patented as U.S. Pat. No. 9,577,267 on Feb. 21, 2017, and entitled “ELECTRODE STRUCTURE AND METHOD FOR MAKING SAME”; U.S. Publication No. US-2013-0095380-A1 published on Apr. 18, 2013, filed as U.S. application Ser. No. 13/644,933 on Oct. 4, 2012, patented as U.S. Pat. No. 8,936,870 on Jan. 20, 2015, and entitled “ELECTRODE STRUCTURE AND METHOD FOR MAKING THE SAME”; U.S. Publication No. US-2012-0052397-A1 published on Mar. 1, 2012, filed as U.S. application Ser. No. 13/216,538 on Aug. 24, 2011, patented as U.S. Pat. No. 9,853,287 on Dec. 26, 2017, and entitled “ELECTROLYTE MATERIALS FOR USE IN ELECTROCHEMICAL CELLS”; U.S. Publication No. US-2014-0123477-A1 published on May 8, 2014, filed as U.S. application Ser. No. 14/069,698 on Nov. 1, 2013, patented as U.S. Pat. No. 9,005,311 on Apr. 14, 2015, and entitled “ELECTRODE ACTIVE SURFACE PRETREATMENT”; U.S. Publication No. US-2014-0193723-A1 published on Jul. 10, 2014, filed as U.S. application Ser. No. 14/150,156 on Jan. 8, 2014, patented as U.S. Pat. No. 9,559,348 on Jan. 31, 2017, and entitled “CONDUCTIVITY CONTROL IN ELECTROCHEMICAL CELLS”; U.S. Publication No. US-2014-0255780-A1 published on Sep. 11, 2014, filed as U.S. application Ser. No. 14/197,782 on Mar. 5, 2014, patented as U.S. Pat. No. 9,490,478 on Nov. 8, 2016, and entitled “ELECTROCHEMICAL CELLS COMPRISING FIBRIL MATERIALS”; U.S. Publication No. US-2014-0272594-A1 published on Sep. 18 2014, filed as U.S. application Ser. No. 13/833,377 on Mar. 15, 2013, and entitled “PROTECTIVE STRUCTURES FOR ELECTRODES”; U.S. Publication No. US-2014-0272597-A1 published on Sep. 18, 2014, filed as U.S. application Ser. No. 14/209,274 on Mar. 13, 2014, patented as U.S. Pat. No. 9,728,768 on Aug. 8, 2017, and entitled “PROTECTED ELECTRODE STRUCTURES AND METHODS”; U.S. Publication No. US-2015-0280277-A1 published on Oct. 1, 2015, filed as U.S. application Ser. No. 14/668,102 on Mar. 25, 2015, patented as U.S. Pat. No. 9,755,268 on Sep. 5, 2017, and entitled “GEL ELECTROLYTES AND ELECTRODES”; U.S. Publication No. US-2015-0180037-A1 published on Jun. 25, 2015, filed as U.S. application Ser. No. 14/576,570 on Dec. 19, 2014, patented as U.S. Pat. No. 10,020,512 on Jul. 10, 2018, and entitled “POLYMER FOR USE AS PROTECTIVE LAYERS AND OTHER COMPONENTS IN ELECTROCHEMICAL CELLS”; U.S. Publication No. US-2015-0349310-A1 published on Dec. 3, 2015, filed as U.S. application Ser. No. 14/723,132 on May 27, 2015, patented as U.S. Pat. No. 9,735,411 on Aug. 15, 2017, and entitled “POLYMER FOR USE AS PROTECTIVE LAYERS AND OTHER COMPONENTS IN ELECTROCHEMICAL CELLS”; U.S. Publication No. US-2014-0272595-A1 published on Sep. 18, 2014, filed as U.S. application Ser. No. 14/203,802 on Mar. 11, 2014, and entitled “COMPOSITIONS FOR USE AS PROTECTIVE LAYERS AND OTHER COMPONENTS IN ELECTROCHEMICAL CELLS”; U.S. Publication No. US-2019-0006699-A1 published on Jan. 3, 2019, filed as U.S. application Ser. No. 15/727,438 on Oct. 6, 2017, and entitled “PRESSURE AND/OR TEMPERATURE MANAGEMENT IN ELECTROCHEMICAL SYSTEMS”; U.S. Publication No. US-2014-0193713-A1 published on Jul. 10, 2014, filed as U.S. application Ser. No. 14/150,196 on Jan. 8, 2014, patented as U.S. Pat. No. 9,531,009 on Dec. 27, 2016, and entitled “PASSIVATION OF ELECTRODES IN ELECTROCHEMICAL CELLS”; U.S. Publication No. US-2014-0127577-A1 published on May 8, 2014, filed as U.S. application Ser. No. 14/068,333 on Oct. 31, 2013, patented as U.S. Pat. No. 10,243,202 on Mar. 26, 2019, and entitled “POLYMERS FOR USE AS PROTECTIVE LAYERS AND OTHER COMPONENTS IN ELECTROCHEMICAL CELLS”; U.S. Publication No. US-2015-0318539-A1 published on Nov. 5, 2015, filed as U.S. application Ser. No. 14/700,258 on Apr. 30, 2015, patented as U.S. Pat. No. 9,711,784 on Jul. 18, 2017, and entitled “ELECTRODE FABRICATION METHODS AND ASSOCIATED SYSTEMS AND ARTICLES”; U.S. Publication No. US-2014-0272565-A1 published on Sep. 18, 2014, filed as U.S. application Ser. No. 14/209,396 on Mar. 13, 2014, and entitled “PROTECTED ELECTRODE STRUCTURES”; U.S. Publication No. US-2015-0010804-A1 published on Jan. 8, 2015, filed as U.S. application Ser. No. 14/323,269 on Jul. 3, 2014, patented as U.S. Pat. No. 9,994,959 on Jun. 12, 2018, and entitled “CERAMIC/POLYMER MATRIX FOR ELECTRODE PROTECTION IN ELECTROCHEMICAL CELLS, INCLUDING RECHARGEABLE LITHIUM BATTERIES”; U.S. Publication No. US-2015-0162586-A1 published on Jun. 11, 2015, filed as U.S. application Ser. No. 14/561,305 on Dec. 5, 2014, and entitled “NEW SEPARATOR”; U.S. Publication No. US-2015-0044517-A1 published on Feb. 12, 2015, filed as U.S. application Ser. No. 14/455,230 on Aug. 8, 2014, patented as U.S. Pat. No. 10,020,479 on Jul. 10, 2018, and entitled “SELF-HEALING ELECTRODE PROTECTION IN ELECTROCHEMICAL CELLS”; U.S. Publication No. US-2015-0236322-A1 published on Aug. 20, 2015, filed as U.S. application Ser. No. 14/184,037 on Feb. 19, 2014, patented as U.S. Pat. No. 10,490,796 on Nov. 26, 2019, and entitled “ELECTRODE PROTECTION USING ELECTROLYTE-INHIBITING ION CONDUCTOR”; U.S. Publication No. US-2015-0236320-A1 published on Aug. 20, 2015, filed as U.S. application Ser. No. 14/624/641 on Feb. 18, 2015, patented as U.S. Pat. No. 9,653,750 on May 16, 2017, and entitled “ELECTRODE PROTECTION USING A COMPOSITE COMPRISING AN ELECTROLYTE-INHIBITING ION CONDUCTOR”; U.S. Publication No. US-2016-0118638-A1 published on Apr. 28, 2016, filed as U.S. application Ser. No. 14/921,381 on Oct. 23, 2015, and entitled “COMPOSITIONS FOR USE AS PROTECTIVE LAYERS AND OTHER COMPONENTS IN ELECTROCHEMICAL CELLS”; U.S. Publication No. US-2016-0118651-A1 published on Apr. 28, 2016, filed as U.S. application Ser. No. 14/918,672 on Oct. 21, 2015, and entitled “ION-CONDUCTIVE COMPOSITE FOR ELECTROCHEMICAL CELLS”; U.S. Publication No. US-2016-0072132-A1 published on Mar. 10, 2016, filed as U.S. application Ser. No. 14/848/659 on Sep. 9, 2015, and entitled “PROTECTIVE LAYERS IN LITHIUM-ION ELECTROCHEMICAL CELLS AND ASSOCIATED ELECTRODES AND METHODS”; U.S. Publication No. US-2018-0138542-A1 published on May 17, 2018, filed as U.S. application Ser. No. 15/567/534 on Oct. 18, 2017, and entitled “GLASS-CERAMIC ELECTROLYTES FOR LITHIUM-SULFUR BATTERIES”; U.S. Publication No. US-2016-0344067-A1 published on Nov. 24, 2016, filed as U.S. application Ser. No. 15/160,191 on May 20, 2016, patented as U.S. Pat. No. 10,461,372 on Oct. 29, 2019, and entitled “PROTECTIVE LAYERS FOR ELECTROCHEMICAL CELLS”; U.S. Publication No. US-2020-0099108-A1 published on Mar. 26, 2020, filed as U.S. application Ser. No. 16/587,939 on Sep. 30, 2019, and entitled “PROTECTIVE LAYERS FOR ELECTROCHEMICAL CELLS”; U.S. Publication No. US-2017-0141385-A1 published on May 18, 2017, filed as U.S. application Ser. No. 15/343,890 on Nov. 4, 2016, and entitled “LAYER COMPOSITE AND ELECTRODE HAVING A SMOOTH SURFACE, AND ASSOCIATED METHODS”; U.S. Publication No. US-2017-0141442-A1 published on May 18, 2017, filed as U.S. application Ser. No. 15/349,140 on Nov. 11, 2016, and entitled “ADDITIVES FOR ELECTROCHEMICAL CELLS”; patented as U.S. Pat. No. 10/320,031 on Jun. 11, 2019, and entitled “ADDITIVES FOR ELECTROCHEMICAL CELLS”; U.S. Publication No. US-2017-0149086-A1 published on May 25, 2017, filed as U.S. application Ser. No. 15/343,635 on Nov. 4, 2016, patented as U.S. Pat. No. 9,825,328 on Nov. 21, 2017, and entitled “IONICALLY CONDUCTIVE COMPOUNDS AND RELATED USES”; U.S. Publication No. US-2018-0337406-A1 published on Nov. 22, 2018, filed as U.S. application Ser. No. 15/983,352 on May 18, 2018, and entitled “PASSIVATING AGENTS FOR ELECTROCHEMICAL CELLS”; U.S. Publication No. US-2018-0261820-A1 published on Sep. 13, 2018, filed as U.S. application Ser. No. 15/916,588 on Mar. 9, 2018, and entitled “ELECTROCHEMICAL CELLS COMPRISING SHORT-CIRCUIT RESISTANT ELECTRONICALLY INSULATING REGIONS”; U.S. Publication No. US-2020-0243824-A1 published on Jul. 30, 2020, filed as U.S. application Ser. No. 16/098,654 on Nov. 2, 2018, and entitled “COATINGS FOR COMPONENTS OF ELECTROCHEMICAL CELLS”; U.S. Publication No. US-2018-0351158-A1 published on Dec. 6, 2018, filed as U.S. application Ser. No. 15/983,363 on May 18, 2018, and entitled “PASSIVATING AGENTS FOR ELECTROCHEMICAL CELLS”; U.S. Publication No. US-2018-0277850-A1, published on Sep. 27, 2018, filed as U.S. application Ser. No. 15/923,342 on Mar. 16, 2018, and patented as U.S. Pat. No. 10,720,648 on Jul. 21, 2020, and entitled “ELECTRODE EDGE PROTECTION IN ELECTROCHEMICAL CELLS”; U.S. Publication No. US-2018-0358651-A1, published on Dec. 13, 2018, filed as U.S. application Ser. No. 16/002,097 on Jun. 7, 2018, and patented as U.S. Pat. No. 10,608,278 on Mar. 31, 2020, and entitled “IN SITU CURRENT COLLECTOR”; U.S. Publication No. US-2017-0338475-A1, published on Nov. 23, 2017, filed as U.S. application Ser. No. 15/599,595 on May 19, 2017, and entitled “PROTECTIVE LAYERS FOR ELECTRODES AND ELECTROCHEMICAL CELLS”; U.S. Publication No. US-2019-0088958-A1, published on Mar. 21, 2019, filed as U.S. application Ser. No. 16/124384 on Sep. 7, 2018, and entitled “PROTECTIVE MEMBRANE FOR ELECTROCHEMICAL CELLS”; U.S. Publication No. US-2019-0348672-A1, published on Nov. 14, 2019, filed as U.S. application Ser. No. 16/470,708 on Jun. 18, 2019, and entitled “PROTECTIVE LAYERS COMPRISING METALS FOR ELECTROCHEMICAL CELLS”; U.S. Publication No. US-2017-0200975-A1, published Jul. 13, 2017, filed as U.S. application Ser. No. 15/429,439 on Feb. 10, 2017, and patented as U.S. Pat. No. 10,050,308 on Aug. 14, 2018, and entitled “LITHIUM-ION ELECTROCHEMICAL CELL, COMPONENTS THEREOF, AND METHODS OF MAKING AND USING SAME”; U.S. Publication No. US-2018-0351148-A1, published Dec. 6, 2018, filed as U.S. application Ser. No. 15/988,182 on May 24, 2018, and entitled “IONICALLY CONDUCTIVE COMPOUNDS AND RELATED USES”; U.S. Publication No. US-2018-0254516-A1, published Sep. 6, 2018, filed as U.S. application Ser. No. 15/765,362 on Apr. 2, 2018, and entitled “NON-AQUEOUS ELECTROLYTES FOR HIGH ENERGY LITHIUM-ION BATTERIES”; U.S. Publication No. US-2020-0044460-A1, published Feb. 6, 2020, filed as U.S. application Ser. No. 16,527,903 on Jul. 31, 2019, and entitled “MULTIPLEXED CHARGE DISCHARGE BATTERY MANAGEMENT SYSTEM”; U.S. Publication No. US-2020-0220146-A1, published Jul. 9, 2020, filed as U.S. application Ser. No. 16/724,586 on Dec. 23, 2019, and entitled “ISOLATABLE ELECTRODES AND ASSOCIATED ARTICLES AND METHODS”; U.S. Publication No. US-2020-0220149-A1, published Jul. 9, 2020, filed as U.S. application Ser. No. 16/724,596 on Dec. 23, 2019, and entitled “ELECTRODES, HEATERS, SENSORS, AND ASSOCIATED ARTICLES AND METHODS”; U.S. Publication No. US-2020-0220197-A1, published Jul. 9, 2020, filed as U.S. application Ser. No. 16/724,612 on Dec. 23, 2019, and entitled “FOLDED ELECTROCHEMICAL DEVICES AND ASSOCIATED METHODS AND SYSTEMS”.

The following examples are intended to illustrate certain embodiments of the present invention, but do not exemplify the full scope of the invention.

### EXAMPLE 1

The following example describes laser cutting and imaging analysis of select sample electrodes that were cut using a laser with the following parameters. NCM cathodes were prepared by using an NMP solvent-based cathode slurry containing NCM811 electroactive material, PVDF binder, and carbon black conductive carbon material to form a deposit. The deposit was coated on 15 μm Al foil substrate (current collector). The coated cathode deposit was dried at 130° C. After drying, the dry cathode formulation contained 96 wt % of electroactive material NCM811, 2.5 wt % of PVDF binder, 1.5 w% of conductive carbon black. The resultant loading was 20 mg of cathode active material/cm²/side.

Tables 1-3 show the laser cutting parameters that were used for cutting each sample. Samples marked with an asterisk (*) were selected for SEM analysis (using back-scattered electrons). A picosecond laser, PL-1.03-25 by Polar Laser Laboratories, wavelength 1030 nm, repetition rate 100 kHz, was used for the samples in Table 1; a Quantronix ODIN Multi-Pass Ti:sapphire amplifier system, wavelength 800 nm, repetition rate 1 kHz, was used for the samples in Table 2; and a Quantronix DARWIN intra-cavity frequency doubled Nd:YLF laser, wavelength 532 nm, repetition rate 1 kHz, pulse duration 100 ns (1/e) and a custom-build (Lenzner Research LLC) Nd:YAG laser, wavelength 1064 nm, repetition rate 1 kHz, pulse duration 100 ns were used to cut the samples in Table 3.

TABLE 1
Laser Cutting Parameters for Samples 1-16

| | Pulse | Pulses | Average | Total | Peak | Cutting |
|---|---|---|---|---|---|---|
| Sample | duration | per | power | fluence | power | speed |
| # | (ps) | burst | (W) | (J/cm²) | (W/cm²) | (mm/s) |
| 1 | 25 | 8 | 7.2 | 5 | 2.9 × 10¹⁰ | 1.0 |
| 2* | 25 | 10 | 9 | 7 | 2.9 × 10¹⁰ | 1.0 |
| 3 | 25 | 10 | 9 | 7 | 2.9 × 10¹⁰ | 2.0 |
| 4* | 25 | 10 | 9 | 7 | 2.9 × 10¹⁰ | 2.0 |
| 5 | 25 | 10 | 9 | 7 | 2.9 × 10¹⁰ | 3.0 |
| 6* | 25 | 10 | 9 | 7 | 2.9 × 10¹⁰ | 5.0 |
| 7* | 25 | 8 | 7.2 | 5 | 2.9 × 10¹⁰ | 2.0 |
| 8 | 25 | 8 | 7.2 | 5 | 2.9 × 10¹⁰ | 3.0 |
| 9 | 100 | 10 | 9 | 7 | 7.2 × 10⁹ | 1.0 |
| 10* | 100 | 10 | 9 | 7 | 7.2 × 10⁹ | 5.0 |
| 11* | 500 | 10 | 9 | 7 | 1.4 × 10⁹ | 5.0 |
| 12 | 500 | 10 | 9 | 7 | 1.4 × 10⁹ | 1.0 |
| 13 | 750 | 10 | 9 | 7 | 9.5 × 10⁸ | 5.0 |
| 14* | 750 | 10.0 | 9.0 | 7 | 9.5 × 10⁸ | 1.0 |
| 15 | 750 | 8.0 | 7.2 | 5 | 9.5 × 10⁸ | 1.0 |
| 16 | 750 | 8.0 | 7.2 | 5 | 9.5 × 10⁸ | 3.0 |

TABLE 2
Laser Cutting Parameters for Samples 20-26

| | | | Average | Pulse | Total | | Cutting |
|---|---|---|---|---|---|---|---|
| Sample | Pulse | | power | energy | fluence | Peak power | speed |
| # | duration | | (W) | (mJ) | (J/cm²) | (W/cm²) | (mm/s) |
| 20*/21* | 50 | fs | 0.88 | 0.88 | 17.5 | 3.5 × 10¹⁴ | 0.5 |
| 22* | 50 | fs | 0.88 | 0.88 | 17.5 | 3.5 × 10¹⁴ | 1.0 |
| 23* | 200 | fs | 0.91 | 0.91 | 18 | 9.0 × 10¹³ | 1.0 |
| 24* | 200 | fs | 0.91 | 0.91 | 18 | 9.0 × 10¹³ | 0.5 |
| 25 | 100 | fs | 0.93 | 0.93 | 18.5 | 1.8 × 10¹⁴ | 1.0 |
| 26 | 100 | fs | 0.93 | 0.93 | 18.5 | 1.8 × 10¹⁴ | 0.5 |
| 27 | 1 | ps | 0.99 | 0.99 | 20 | 2.0 × 10¹³ | 1.0 |
| 28 | 1 | ps | 0.99 | 0.99 | 20 | 2.0 × 10¹³ | 1.8 |
| 29 | 1 | ps | 0.99 | 0.99 | 20 | 2.0 × 10¹³ | 0.5 |
| 30 | 25 | ps | 0.97 | 0.97 | 19 | 7.6 × 10¹¹ | 0.5 |
| 31* | 25 | ps | 0.97 | 0.97 | 19 | 7.6 × 10¹¹ | 1.0 |
| 32* | 25 | ps | 1.9 | 1.9 | 38 | 1.5 × 10¹² | 1.0 |
| 33 | 25 | ps | 1.9 | 1.9 | 38 | 1.5 × 10¹² | 0.5 |
| 34 | 1 | ps | 2.0 | 2.0 | 40 | 4.0 × 10¹³ | 1.0 |
| 35 | 1 | ps | 2.0 | 2.0 | 40 | 4.0 × 10¹³ | 2.0 |
| 36 | 1 | ps | 2.0 | 2.0 | 40 | 4.0 × 10¹³ | 0.5 |

TABLE 3
Laser Parameters for Samples

| | | | | | |
|---|---|---|---|---|---|
| | Average | Pulse | Total | Peak | Cutting |
| Sample | power | energy | fluence | power | speed |
| # | (W) | (mJ) | (J/cm²) | (W/cm²) | (mm/s) |

Laser: Quantronix DARWIN Nd:YLF

| | | | | | |
|---|---|---|---|---|---|
| 37* | 4.2 | 4.2 | 214 | 2.1 × 10⁹ | 1.0 |
| 38 | 6.25 | 6.25 | 318 | 3.2 × 10⁹ | 3.0 |
| 39 | 9.8 | 9.8 | 499 | 5.01 × 10⁹ | 15.0 |
| 40 | 12.1 | 12.1 | 616 | 6.2 × 10⁹ | 20.0 |
| 41* | 14.8 | 14.8 | 754 | 7.5 × 10⁹ | 22.0 |

Laser: Home-build Nd:YAG

| | | | | | |
|---|---|---|---|---|---|
| 42* | 4.0 | 4.0 | 104 | 1.0 × 10⁹ | 1.0 |
| 43 | 11.0 | 11.0 | 286 | 2.9 × 10⁹ | 15.0 |
| 44* | 15.5 | 15.5 | 403 | 4.0 × 10⁹ | 22.0 |

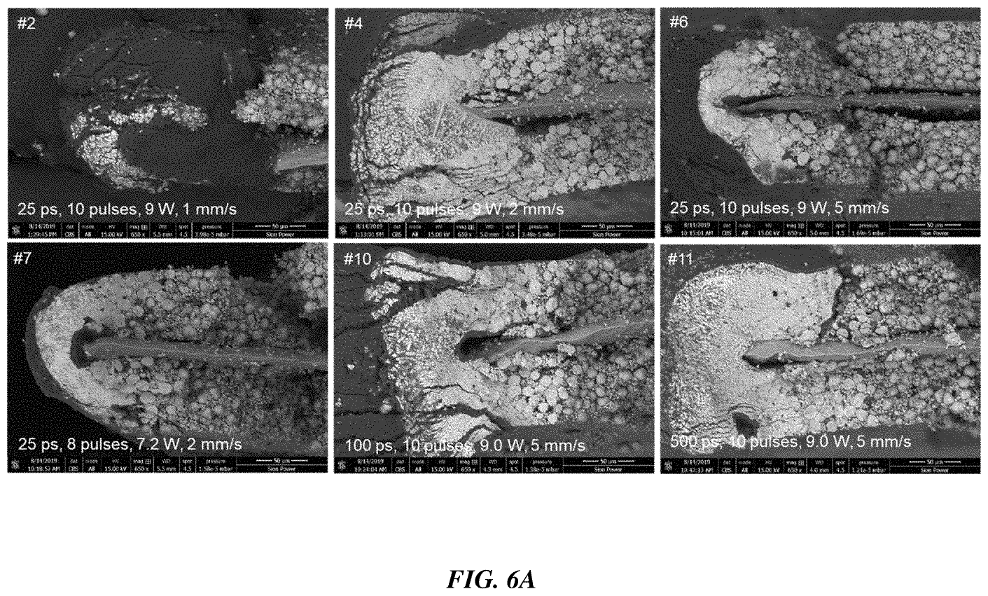

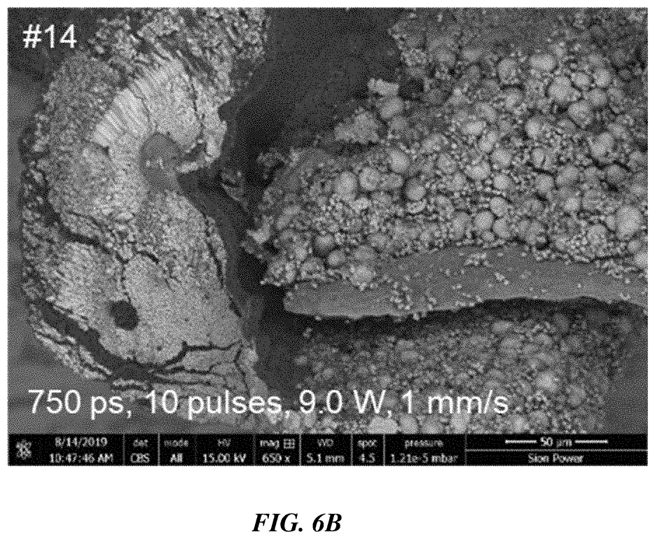

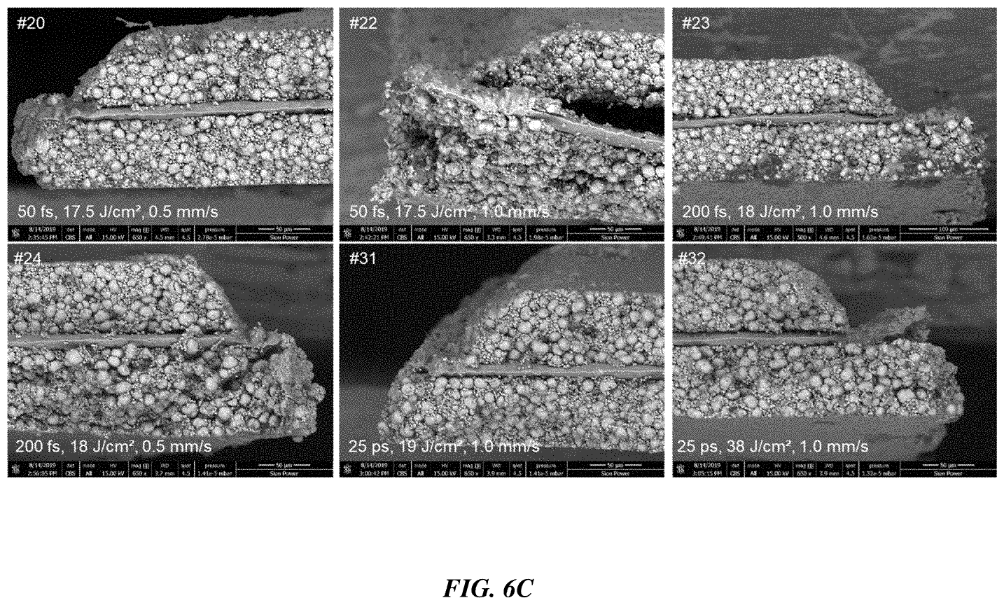

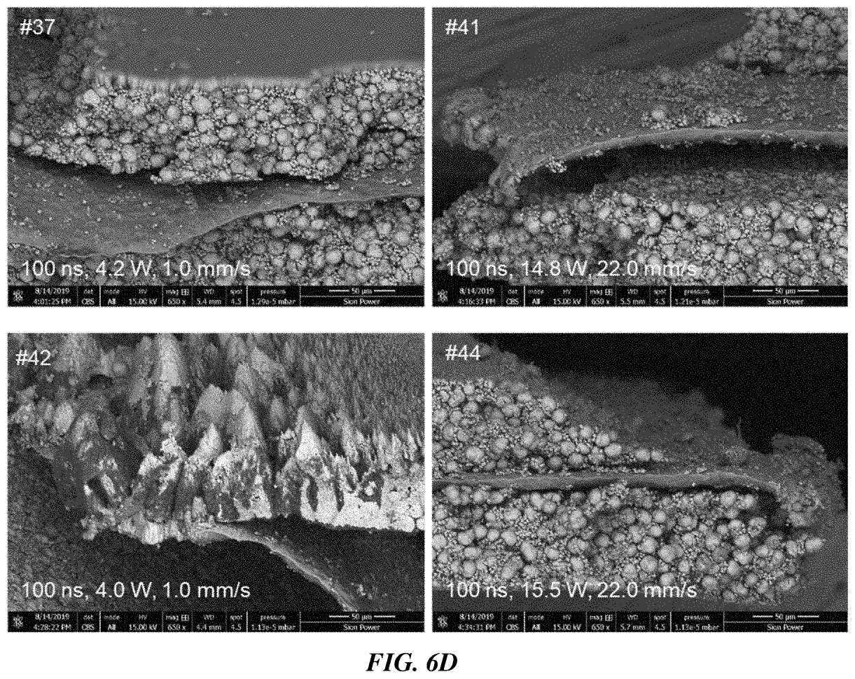

The changes in element distribution at cathode edges can be shown by backscattered electron SEM mode (BSE), as well as the effects of cathode edge morphology and element distribution. For example, FIGS. 6A-6B show cross-sectional SEM images (BSE) of select samples cut using the parameters of Tables 1-3. The laser-cut cathode edges shown in FIGS. 6A-6C were prepared by mechanically cleaving (e.g., tearing) the cathode in a direction normal to the laser-cutting direction so that morphological and elemental changes of the laser-cut cathode material could be shown with respect to laser-cut edge. FIGS. 6A-6B corresponds to SEM images of laser-cut cathode edges cut with the picosecond laser while FIG. 6C corresponds to the SEM images of several of the samples laser cut with the femtosecond laser. FIG. 6D corresponds to SEM images of cathode edges cut with nanosecond lasers. The current collector and electroactive layers can be seen in the sample. Each sample shows significant morphology and composition changes at the laser-cut edge. Fusion and recrystallization of multiple NCM particles into larger clusters is evident at the edges.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An electrode, comprising:
an electroactive layer comprising an electroactive material configured to intercalate and/or deintercalate an electroactive species,
wherein the electroactive layer comprises a non-electroactive material disposed on an edge of on the electroactive layer, wherein the non-electroactive material is impermeable to the electroactive species.

2. An electrode, comprising:
an electroactive layer comprising a plurality of particles, the plurality of particles comprising an electroactive material configured to intercalate and/or deintercalate an electroactive species,
wherein an edge of the electroactive layer comprises at least a portion of the plurality of particles that are fused particles, and
wherein an interior portion of the electroactive layer comprises at least a portion of the plurality of particles that are unfused particles.

3. An electrode, comprising:
an electroactive layer comprising a first material wherein the first material is single crystalline; and
an edge of the electroactive layer comprising a second material,
wherein the second material is polycrystalline or amorphous.

4-6. (canceled)

7. The electrode of claim 1, wherein the electroactive material comprises a conductive carbon material, a 2-dimensional layered material, and/or a lithium intercalation compound.

8. The electrode of claim 1, further comprising a current collector with a front surface and an opposing back surface.

9. The electrode of claim 8, wherein the electroactive layer is disposed on the front surface and/or the back surface.

10. The electrode of claim 8, wherein the current collector comprises aluminum.

11. The electrode of claim 2, wherein at least some the fused particles comprise joined interior portions of the particles.

12. The electrode of claim 2, wherein the fused particles are impermeable to the electroactive species.

13. The electrode of claim 1, wherein the electroactive species comprises lithium ions.

14. The electrode of claim 1, further comprising a separator, wherein the separator comprises a polymer.

15. The electrode of claim 3, wherein the first material comprises a first phase.

16. The electrode of claim 3, wherein the second material comprises a second phase.

17. The electrode of claim 1, wherein the non-electroactive material is absent in an interior portion of the electroactive layer.

18-23. (canceled)
